(19) United States
(12) Patent Application Publication
(10) Pub. No.: US 2014/0052494 A1
(43) Pub. Date: Feb. 20, 2014

(54) Identifying Scenarios and Business Units that Benefit from Scenario Planning for Operational Risk Scenario Analysis Using Analytical and Quantitative Methods

(71) Applicant: Ajay Kumar Anne, Peoria, IL (US)

(72) Inventor: Ajay Kumar Anne, Peoria, IL (US)

(73) Assignee: Bank of America, Charlotte, NC (US)

(21) Appl. No.: 13/587,782

(22) Filed: Aug. 16, 2012

(51) Int. Cl. G06Q 10/00

(52) U.S. Cl. 705/7.28

(57) ABSTRACT

Methods, computer-readable media, and apparatuses are disclosed for risk scenario analysis. Aspects of the embodiments disclose methods, computer readable media, and apparatuses for identifying scenarios for operational risk scenario analysis using analytical and quantitative methods. Additional aspects of the embodiments disclose methods, computer readable media, and apparatuses for identifying business units for performing risk scenario analysis using analytical and quantitative methods.

### FIELD

Aspects of the embodiments relate to methods, computer readable media, apparatuses, or computer systems that identify scenarios for operational risk scenario analysis using analytical and quantitative methods. Aspects of the embodiments also relate to methods, computer readable media, apparatuses, or computer systems that identify business units for risk scenario analysis planning

### BACKGROUND

Risk management is a process that allows any associate within or outside of a technology and operations domain to balance the operational and economic costs of protective measures while protecting the operations environment that supports the mission of an organization. Risk is the net negative impact of the exercise of vulnerability, considering both the probability and the impact of occurrence.

An organization typically has a mission. Risk management plays an important role in protecting against an organization's operational risk losses or failures. An effective risk management process is an important component of any operational program. The principal goal of an organization's risk management process should be to protect against operational losses and failures, and ultimately the organization and its ability to perform the mission.

Scenarios may be forward-looking statements about certain hypothetical events. Scenario analysis (also known as scenario planning or scenario thinking) is a strategic planning method used by organizations to help manage risk. Scenario analysis may also be required by regulatory agencies. Within the financial industry, the Basel II Capital Accord requires firms conduct scenario analysis. Executive management, policy managers, military intelligence, federal emergency planning (within FEMA) may use scenario analysis in decision-making. Scenario analysis may help in taking advantage of the unexpected as well as for good risk management.

In the banking industry, the Federal Reserve has used scenarios to stress test the risk exposures of a financial institution during any of the recent financial crisis. Also, beyond the banking industry, executive management, policy makers, military intelligence, Federal Emergency Planning (FEMA), and other similar organizations/groups may use scenario analysis in decision-making. Scenario analysis helps in “taking advantage of the unexpected” as well as providing good risk management. Scenario analysis may augment the understanding of the future and help in capital allocation or other financial decisions.

The mechanics of scenario planning, such as conducting scenario workshops to derive/deduce the likelihood and impact of a given scenario, identifying and reducing bias during scenario analysis workshop, and/or use of scenario workshop data in risk management, have been the focus of scenario planning. However, two critical elements in the scenario analysis process are: a) quantitatively (fact-based) determining which business units or departments of a firm can benefit from scenario planning exercises” and b) quantitatively (fact-based) identification of pertinent scenarios at a given time. This identification of the right, pertinent, and plausible scenarios as well as identification of specific business units of the firm that benefit from scenario planning remains an elusive and challenging problem

For operational risk measurement and management domain (as opposed to market risk or credit risk), the problem of identifying tail risk becomes all the more challenging partly due to the heterogeneity of risks. Tail risk may be those risks that are extreme loss events. Operational risks may include and not be limited to examples such as: rogue trading, supplier financial viability risk, breach of data hosted by a third party vendor, anti-trust issues, patent infringement lawsuits, market manipulation, external fraud such as robbery or taking information, systems failures, disasters such as hurricanes. Additionally, there are multiple sources of risk information providing a comprehensive view, yet this information is rarely distilled down to the specific details required for the selection of scenarios to be run on tail risks.

Additionally, complicating the situation is that scenario workshops are expensive to run. Many times, on an annual basis, organizations participate in scenario workshops with anywhere between 50 and 250 organizational/enterprise scenarios are run in one or more workshops a year. Additionally, line of business, or divisions, or control functions may run their own scenario workshops as well. Organizations may spend significant time and resources on the scenario analysis, from planning to execution to usage of the results in remediation planning, risk transfer, or mitigation. All these activities require significant investment in key associate time and resources. Hence, there is a need to identify the critical few scenarios that an organization should focus on in a given year.

Further complicating the situation, multiple sources of risk information may provide a comprehensive but siloed perspective/view, yet may rarely distill down to specific pointers as to the specific scenarios that need to be performed or run on tail risks (extreme loss events). Another aspect complicating the scenario analysis may be multi-national firms with heterogeneous business units and departments, where it may be generally unclear which business unit(s) can benefit from scenario planning. Therefore, scenario selection and scenario development can be characterized as a balancing act between creativity and qualitative emphasis on one extreme and analytical rigor and fact basis on the other extreme.

In scenario selection, there may be opposing forces at play. On one side, execution time and cost indicate a smaller set of scenarios run by a smaller set of business units. On other side, heterogeneity of operational risks, wide exposure by business units, and value of scenario analysis in risk measurement and management indicate a comprehensive set of scenarios executed by a larger set of business units. Every organization may need to optimize between these two opposing push-pull factors. Fact-based (quantitative and analytical) determination of scenarios, as well as specific business units that may benefit from scenarios, is most sought after but rarely achieved in practice.

### BRIEF SUMMARY

Aspects of the embodiments address one or more of the issues mentioned above by disclosing methods, computer readable media, and apparatuses for identifying scenarios for operational risk scenario analysis using analytical and quantitative methods. Additional aspects of the embodiments address one or more of the issues mentioned above by disclosing methods, computer readable media, and apparatuses for identifying business units for performing risk scenario analysis using analytical and quantitative methods.

According to an aspect of the invention that selects a specific set of scenarios, a computer-assisted method that provides identification of scenarios for operational risk scenario analysis using analytical and quantitative methods. The method may include the steps of: 1) identifying a set of risk factors; 2) analytically deriving, by a risk scenario computer system, potential risk scenarios from the set of risk factors; 3) analytically deriving, by the risk scenario computer system, prioritization information from the set of risk factors; 4) developing a prioritization scheme that rank-orders the potential risk scenarios; and 5) outputting, by the risk scenario computer system, a prioritized set of potential risk scenarios, wherein the prioritized set of potential risk scenarios identifies risk scenarios for operational risk scenario analysis. The method may further comprise the step of: conducting, by the risk scenario computer system, what-if-analysis testing of the prioritized set of potential risk scenarios. Additionally, the what-if-analysis testing may include changing parameters during the deriving of potential risk scenarios step. In another embodiment, the what-if-analysis testing may include changing parameters during the deriving of prioritization information step. Additionally, the set of risk factors may include emerging risk information. The set of risk factors may also include internal loss data derived from a Basel Pareto chart, loss recovery rates, and/or internal loss tail events. Further, the set of risk factors may include external loss data derived from a Basel Pareto chart and/or external loss tail events.

According to another aspect of this invention that identifies specific business units in a given firm that benefits from scenario analysis, an apparatus may comprise: at least one memory; and at least one processor coupled to the at least one memory and configured to perform, based on instructions stored in the at least one memory: 1) defining critical to quality measures of success and line of business granularity, wherein the line of business granularity defines a set of line of businesses for assessing a scenario analysis; 2) identifying a set of risk factors and obtaining information related to the set of risk factors; 3) defining a prioritization scheme for the set of risk factors, wherein the prioritization scheme is aligned with the critical to quality measures of success; 4) quantitatively analyzing, by a risk scenario computer system, the set of risk factors and the prioritization scheme, wherein the quantitative analysis includes normalizing the data, and calculating a composite score for each of the lines of business within the set of line of businesses; 5) determining risk factor thresholds above which business unit scenario planning is deemed necessary for each of the lines of business within the set of line of businesses; and 6) selecting a business unit based on the risk factor thresholds for scenario planning.

According to aspects of the invention that identifies specific business units in a given firm that benefits from scenario analysis, the set of risk factors may include extreme internal loss factors, large internal loss factors, large external loss factors, self-assessed residual risk factors, and self-assessed inherent risk factors, and environmental stress factors and emerging risks. Furthermore, the extreme internal loss factors, large internal loss factors, and large external loss factors may include number of loss events and severity of the loss events. Additionally, the self-assessed residual risk factors and the self-assessed inherent risk factors may include risk trends over time and the current state of risk.

According to another aspect of the invention that identifies specific business units in a given firm that benefits from scenario analysis, the set of risk factors may include environmental stress factors and emerging risks that include one or more of the following: people factors, process factors, systems factors, external events, strategic factors, customer factors, regulatory factors, and financial factors.

According to another aspect of the invention that identifies specific business units in a given firm that benefits from scenario analysis, a computer-readable storage medium storing computer-executable instructions that, when executed, cause a processor to perform a method may comprise the steps of: defining critical to quality measures of success and line of business granularity, wherein the line of business granularity defines a set of line of businesses for assessing a scenario analysis; identifying a set of risk factors and obtaining information related to the set of risk factors; defining a prioritization scheme for the set of risk factors, wherein the prioritization scheme is aligned with the critical to quality measures of success; quantitatively analyzing, by a risk scenario computer system, the set of risk factors and the prioritization scheme, wherein the quantitative analysis includes normalizing the data, and calculating a composite score for each of the lines of business within the set of line of businesses; determining risk factor thresholds above which business unit scenario planning is deemed necessary for each of the lines of business within the set of line of businesses; selecting a business unit based on the risk factor thresholds for scenario planning; identifying a set of risk factors; analytically deriving, by the risk scenario computer system, potential risk scenarios from the set of risk factors; analytically deriving, by the risk scenario computer system, prioritization information from the set of risk factors; developing a prioritization scheme that rank-orders the potential risk scenarios; and outputting, by the risk scenario computer system, a prioritized set of potential risk scenarios, wherein the prioritized set of potential risk scenarios identifies risk scenarios for operational risk scenario analysis.

Additionally, the method to identify scenarios may further comprise the step of conducting, by the risk scenario computer system, what-if-analysis testing and sensitivity testing of the quantitative analysis of the set of risk factors and the prioritization scheme. According to another aspect of the invention to identify scenarios, the set of risk factors includes: emerging risk information; internal loss data derived from a Basel Pareto chart, loss recovery rates, and/or internal loss tail events; and external loss data derived from a Basel Pareto chart and/or external loss tail events. The method may also include the step of conducting, by the risk scenario computer system, what-if-analysis testing of the prioritized set of potential risk scenarios.

These and other aspects of the embodiments are discussed in greater detail throughout this disclosure, including the accompanying drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative operating environment in which various aspects of the invention may be implemented.

FIG. 2 is an illustrative block diagram of workstations and servers that may be used to implement the processes and functions of certain aspects of the present invention.

FIG. 3 illustrates a flow chart for a prior art system for scenario analysis.

FIGS. 4 and 5 illustrate a flow chart for identifying business units for scenario planning.

FIGS. 6 through 14 show various illustrative tables for use with example embodiments in accordance with aspects of the invention that identifies business units for scenario planning.

FIGS. 15A and 15B illustrate flow charts for identifying scenarios and prioritizing scenarios in accordance with an aspect of the invention.

FIGS. 16 through 18 show various illustrative tables for use with example embodiments in accordance with aspects of the invention that identifies prioritized scenarios.

### DETAILED DESCRIPTION

In accordance with various aspects of the invention, methods, computer-readable media, and apparatuses are disclosed for analytically deriving scenarios, prioritizing scenario information from multiple sources of pertinent information, rank-ordering the scenarios, and outputting the scenario line-up. This method/process minimizes randomness in scenario selection and business unit selection. Additionally, although subjectivity is not eliminated entirely, the subjectivity is constrained to select aspects of the framework of this method/process, such as selecting weights to components. Therefore, clear transparency may be thus achieved as to why the selected scenarios are selected over the initial set of candidate scenarios that are applicable to an organization or firm.

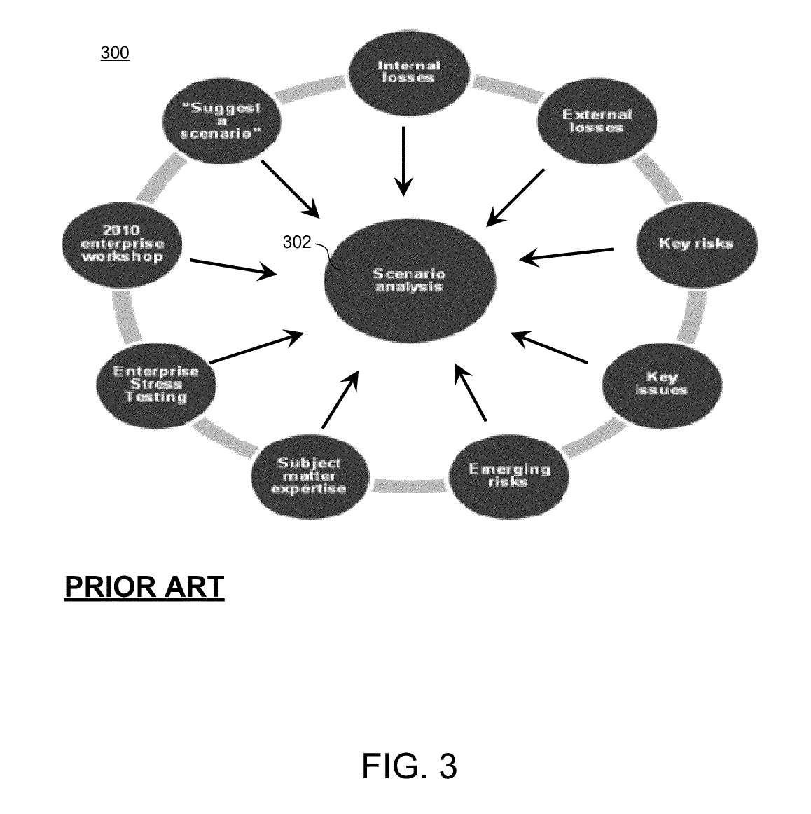

FIG. 3 illustrates a sample prior art model 300 for scenario analysis 302. As illustrated in FIG. 3, the prior art process for scenario analysis 302 may include many different activities, such as a prior year's scenario workshop, organization/enterprise testing, suggesting a scenario, and the use of subject matter expertise. Additionally, many additional inputs may go into this prior art scenario analysis, such as internal losses, external losses, key risks, key issues, and emerging risks. As was described above, this scenario analysis prior art system 302 can be very resource intensive and in the end may not even output the best or most useful results, since the manner of data aggregation is unclear with no transparency, and in the end when employed by different persons in the organization can result in a different set of scenarios. This variability and randomness in identification of scenarios applies to the identification of business units where scenario planning can be beneficial.

Most scenario analysis prior art focuses on detailing scenario workshop methodology, such as: assigning likelihood and impact ratings of a given scenario, reducing biases from workshop participants, usage of scenario workshop outputs in risk management programs, usage of scenario outputs in risk measurement and capital estimation. Currently, there is no quantitative framework, methods, or processes that actually identifies and selects scenarios (and departments within an organization) that are pertinent to that organization at a given point of time using empirical data and analytical approaches.

According to one aspect of the invention, identifying business units that can benefit from scenario analysis/planning exercises may include one or more of the following steps: 1) define critical to quality measures of success; 2) determine line of business granularity; 3) identify factors that serve as input into the decision-making process; 4) obtain management information related to the above factors; 5) input/record data for data manipulation and data analysis; 6) visually depict output of the data into a 2-dimensional heat-map; 7) define prioritization scheme keeping in alignment with defined primary critical to quality; 8) quantitatively synthesize the data; 9) determine thresholds above which scenario planning is deemed helpful; and 10) conduct “what-if” analysis and sensitivity testing of the results.

According to another aspect of the invention, identifying scenarios for operational scenario analysis using analytical and quantitative methods may include one or more of the following steps: 1) identifying factors that serve as input into the decisioning process; 2) analytically deriving potential scenarios from multiple sources of pertinent risk information; 3) analytically deriving prioritization information from multiple sources of pertinent risk information; 4) developing a prioritization scheme that rank-orders the potential scenarios; 5) outputting a prioritized set of potential organization/enterprise scenarios; and 6) conducting “what-if-analysis” and sensitivity testing of the results.

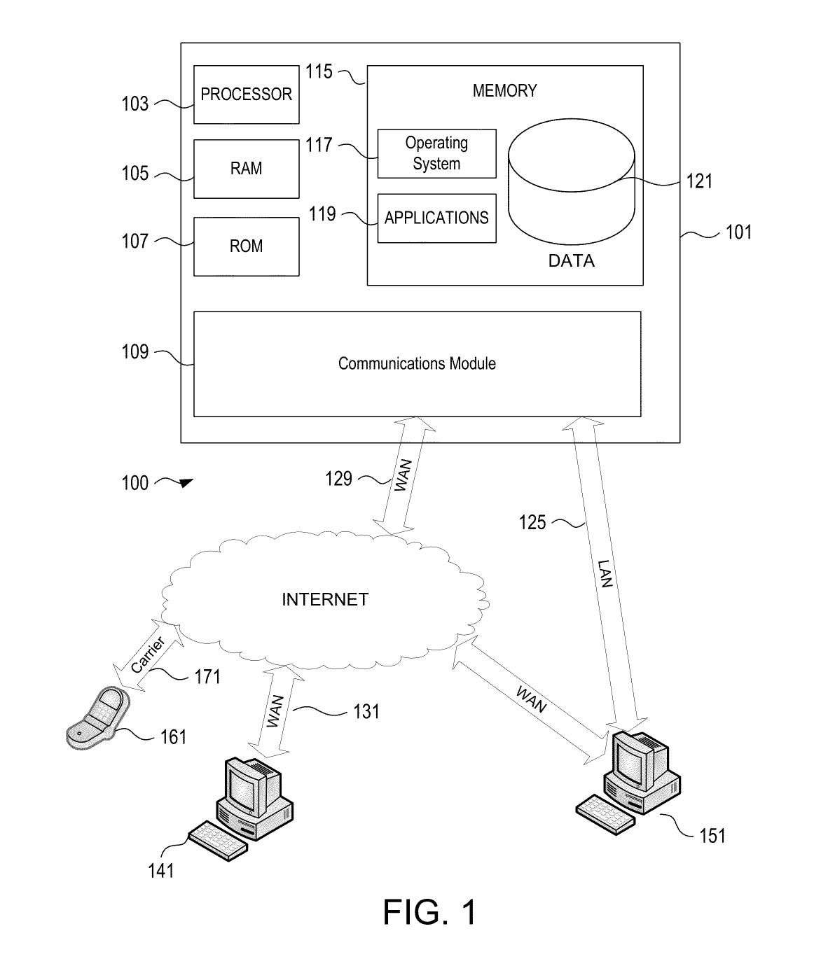

FIG. 1 illustrates an example of a suitable computing system environment 100 that may be used according to one or more illustrative embodiments. The computing system environment 100 is only one example of a suitable computing environment and is not intended to suggest any limitation as to the scope of use or functionality of the invention. The computing system environment 100 should not be interpreted as having any dependency or requirement relating to any one or combination of components shown in the illustrative computing system environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including RAM 105, ROM 107, communications module 109, and memory 115. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown). Exemplary usages include scanning and converting paper documents, e.g., correspondence, receipts, to digital files.

Although not shown, RAM 105 may include one or more are applications representing the application data stored in RAM memory 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Alternatively, some or all of the computer executable instructions for computing device 101 may be embodied in hardware or firmware (not shown). Database 121 may provide centralized storage of risk information including attributes about identified risks, characteristics about different risk frameworks, and controls for reducing risk levels that may be received from different points in system 100, e.g., computers 141 and 151 or from communication devices, e.g., communication device 161.

Computing device 101 may operate in a networked environment supporting connections to one or more remote computing devices, such as branch terminals 141 and 151. The branch computing devices 141 and 151 may be personal computing devices or servers that include many or all of the elements described above relative to the computing device 101. Branch computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, computing device 101 is connected to the LAN 125 through a network interface or adapter in the communications module 109. When used in a WAN networking environment, the server 101 may include a modem in the communications module 109 or other means for establishing communications over the WAN 129, such as the Internet 131. It will be appreciated that the network connections shown are illustrative and other means of establishing a communications link between the computing devices may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages. The network connections may also provide connectivity to a CCTV or image/iris capturing device.

Additionally, one or more application programs 119 used by the computing device 101, according to an illustrative embodiment, may include computer executable instructions for invoking user functionality related to communication including, for example, email, short message service (SMS), and voice input and speech recognition applications.

Embodiments of the invention may include forms of computer-readable media. Computer-readable media include any available media that can be accessed by a computing device 101. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the invention is contemplated. For example, aspects of the method steps disclosed herein may be executed on a processor on a computing device 101. Such a processor may execute computer-executable instructions stored on a computer-readable medium.

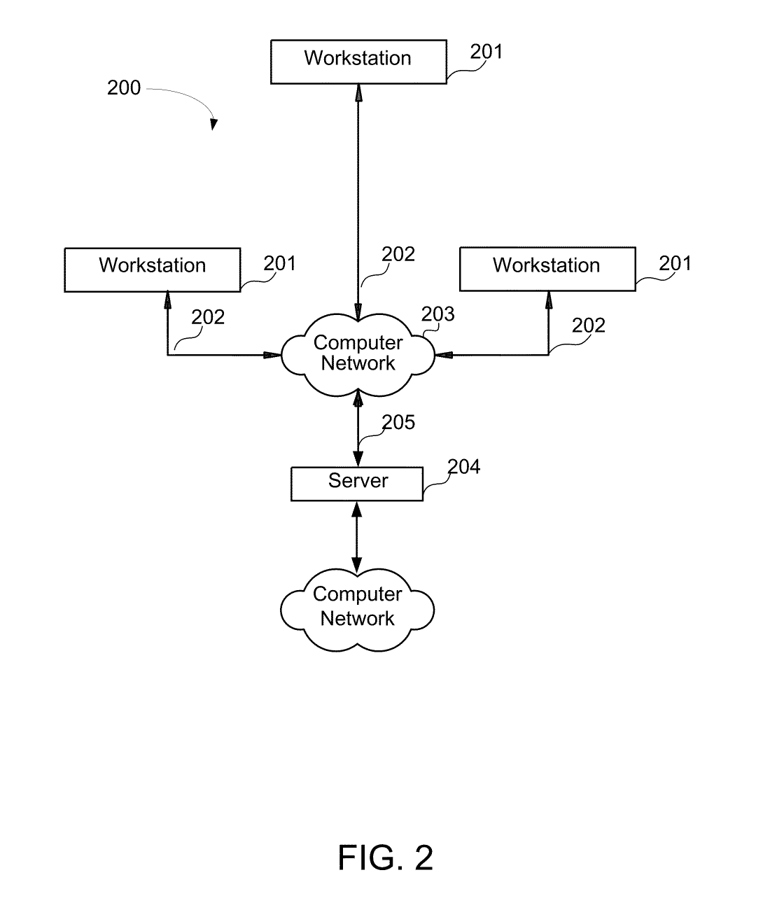

Referring to FIG. 2, an illustrative system 200 for implementing methods according to the present invention is shown. The system 200 may be a risk scenario system or a risk management system in accordance with aspects of this invention. As illustrated, system 200 may include one or more workstations 201. Workstations 201 may be local or remote, and are connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links. Connectivity may also be supported to a CCTV or image/iris capturing device.

The steps that follow in the figures may be implemented by one or more of the components in FIGS. 1 and 2 and/or other components, including other computing devices.

An aspect of the invention provides a process for identifying both scenarios and business units that may benefit from scenario planning for operational risk scenario analysis using analytical and quantitative methods. The two part solution identifies (a) business units that can benefit from scenario analysis/planning exercises and also (b) the specific set of scenarios that may be run by a specific business unit at a given snapshot in time. The methods and processes may analytically derive scenarios and scenario prioritization information from multiple sources of pertinent information and then rank-order that information to output a scenario line-up. These methods and processes may minimize randomness in scenario selection and enhance transparency in identifying/developing scenarios. These methods and processes may also provide “what-if” capability to the scenario process team and other stakeholders, with the ability to tweak certain weights to individual components of information to arrive at a different set of results. Even though the emphasis is on fact-based determination, by design, subjective opinions and the voice of the customer may also be utilized. Within these methods and processes, although subjectivity is not eliminated totally, the subjectivity is constrained to select aspects of the framework (such as selecting weights to information classes/components). Clear transparency may be thus achieved as to why certain operational risk scenarios are selected over other from a comprehensive initial set of candidate scenarios that are applicable to large firms.

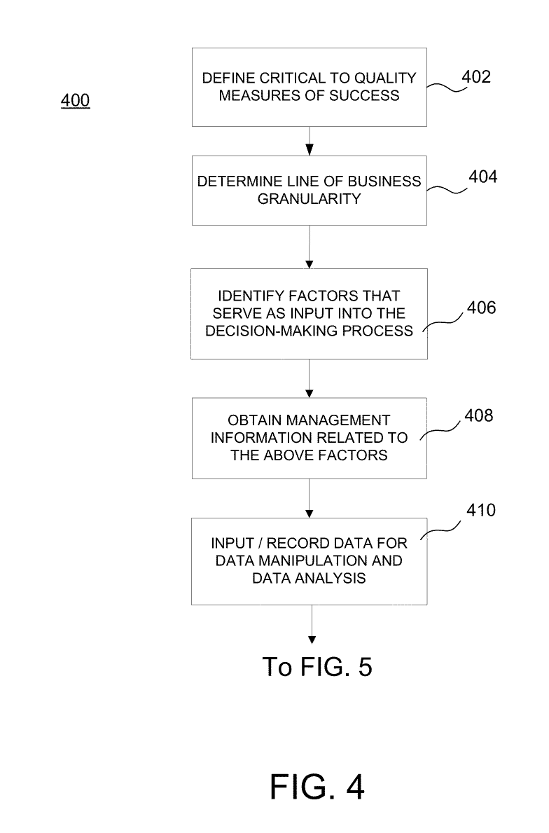

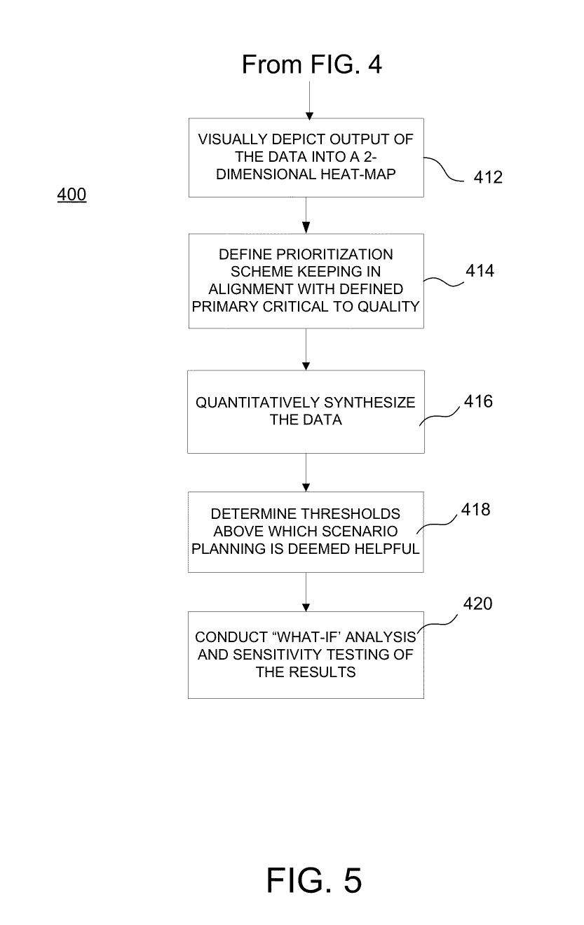

FIGS. 4 and 5 show a flow chart for identifying business units that can benefit from scenario analysis/planning exercise. This identification of business units allows understanding the likelihood and impact of key risks with potential to translate into large/extreme operational losses. As illustrated in FIGS. 4 and 5, the method may include one or more of the following steps: 1) defining critical to quality measures of success 402; 2) determining line of business granularity 404; 3) identifying factors that serve as input into the decision-making process 406; 4) obtaining management information related to the above factors 408; 5) inputting and recording data for data manipulation and data analysis 410; 6) depicting visually the output of the data into a 2-dimensional heat-map 412; 7) defining prioritization scheme keeping in alignment with defined primary critical to quality 414; 8) quantitatively synthesize the data 416; 9) determining thresholds above which scenario planning is deemed helpful 418; and 10) conducting “what-if” analysis and sensitivity testing of the results 420.

FIG. 4 illustrates the first step in the process, defining critical to quality (CTQs) measures of success 402. CTQs may be tailored to the organizational needs with respect to scenario analysis and may include, but not be limited to, any of the following CTQs. One CTQ may be balanced number of decision-making factors, for example, not too few numbers of decisioning factors nor too many decisioning factors. Another CTQ may be simple, straight-forward and a flexible prioritization scheme with an ability to perform what-if analysis. For this CTQ, the prioritization scheme may not be too simple as to over simplify the reality, nor overly complex that the scheme is difficult to explain to managers and/or executive stakeholders. Another CTQ may be data availability, either readily available, nor can be obtained with reasonable effort. External loss databases may be limited in terms of data collection/reporting service level agreements. Another CTQ may be transparency of risks, such as input data, methodology, and output scores. Another CTQ may be to provide the ability to take appropriate actions, for example with a heat-map for visualization of hotspots. Another CTQ may be organization alignment.

FIG. 4 illustrates another step in the process, determining line of business granularity 404 at which the work will be performed and the scenario analysis is planned to be executed. In some organizations, scenario workshops and planning is performed at major lines of business, such as 1-down level, and in other organizations, scenario analysis is conducted a highly granular levels, such as 3-down levels.

In accordance with aspects of this invention, there may be business units 1-down level, business units 2-down level, and business units 3-down level associated with the organizational structure for an organization. Additional down levels may be associated with an organizational structure for an organization without departing from this invention. Business units 1-down level may include, but not be limited to the following examples: consumer and small business banking; global commercial banking; global wealth and investment management; home loans; insurance services; legacy asset servicing; and global banking and marketing.

For each of the business units 2-down levels, the lines of business (LOB) 2 down may be associated or linked with an LOB 1 down level. Business units 2-down levels may include, but not be limited to the following examples: consumer banking products, distribution, mass affluent and small business segment and strategy and planning, mass market segment and strategy and planning, preferred and small business banking, roll up, business banking, client development group, commercial real estate banking, enterprise client coverage, middle market banking, specialized industries, global capital management, global investment solutions, global wealth and investment management banking, private banking and investment group, retirement services, US trust, US trust management, customer experience and mortgage operations, home loans servicing, underwriting and fulfillment, credit loss mitigation, default servicing, global corporate banking, global investment banking and capital markets, and global markets.

For each of the business units 3-down levels, the lines of business (LOB) 2 down may be associated or linked with an LOB 1 down level or an LOB 2 down level. Some example business units 3-down levels may include, but not be limited to: deposits and card products, business capital, dealer financial services, global leasing, global treasury sales, international subsidiary businesses, treasury product solutions, global capital markets, global investment banking, commodities, equities, global credit products, global loans and special situations, global mortgage products, and global rates and currencies.

For each of the above business unit designations, 1-down level, 2-down level, and 3-down level, various different business units and structures may be included without departing from this invention. The type of organization may also greatly affect the various business unit designations. These are just example types/names of business unit designations. Any business unit designation may be utilized without departing from this invention. The key for this step is the identification of the business units and their granularity at which the work will be performed and the scenario analysis is planned to be executed.

FIG. 4 illustrates another step in the process, identifying factors that serve as input into the decision-making process 406. The below list of factors may be treated as suggested factors and are labeled F1 through F18 for convenience. Additional factors such as key risk indicators, audit/regulatory identified issues, emerging risks identified in internal databases may be easily incorporated in addition to what is listed below without departing from this invention.
i. Extreme Internal Loss (greater than $100 MM) factors (with empirical data from historical internal loss database)
   F1—number of events
   F2—severity of the events
ii. Large Internal Loss (greater than $10 MM) factors (with empirical data from historical internal loss database)
   F3—number of events
   F4—severity of the events
iii. Large External Loss (greater than Euro 10 MM) factors (with empirical data from historical external loss database)
F5—number of events
   F6—severity of the events
iv. Self-assessed Residual Risks from Firm Internal RCSA (risk and control self-assessment) process
   F7—trends over time (2 possible options)
   F8—current state of residual risk
v. Self-assessed Inherent Risks from Firm Internal RCSA (risk and control self-assessment) process
   F9—trends over time (2 possible options)
   F10—current state of inherent risk
vi. Environmental Stress Factors & Emerging Risks. Note that certain critical stress factors may be hypothesized to act as precursors (nucleus) to emerging operational loss events when combined with trigger events (e.g., macro-economic factors or firm-specific factors)
   F11—people
   F12—process
   F13—systems
   F14—external events
   F15—strategic
   F16—customer
   F17—regulatory
   F18—financial

If emerging risks are available in risk/line of business databases and for each of the emerging risks, the severity, occurrence, and detection are quantified and captured on say a 1 to 5 scale, a risk prioritization number (RPN) may be obtained by multiplying severity with occurrence and detection. This RPN may be used as an emerging risk factor after due customization according to the needs of the firm.

FIG. 4 illustrates another step in the process, obtaining management information related to the factors 408. Each of the above identified and defined factors listed in the previous step 406 may be analyzed with additional management information. Many different methods may be utilized to achieve this and display and analyze this management information.

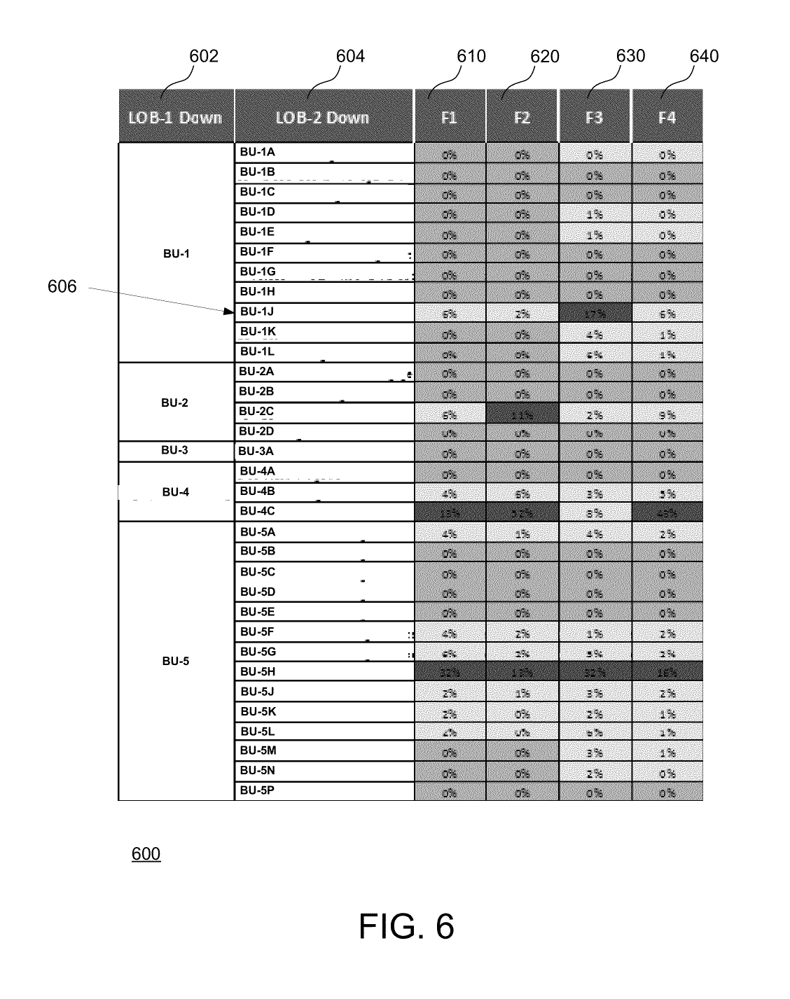

For example, as illustrated in FIG. 6, a table 600 may be utilized to show additional management information for factors F1 through F4. Factors F1 610, F2 620, F3 630, and F4 640 may be based on internal historical losses and therefore the number and loss amounts of tail risk events should be readily available from an internal loss database. Additionally, these factors F1 through F4 may be listed for the LOB-1 down levels 602 (represented as BU-1 through BU-5) and the LOB-2 down levels 604 (represented, for example, as BU-1A through BU-1L). As an example as illustrated in the table 600 in FIG. 6, BU-1 (LOB 1-down) and BU-1J (LOB-2 down) 606 had a 6% by volume of extreme losses, listed under factor F1 610 in the table 600. Similarly, the same unit 606 on a value ($ amount) is 2% listed under factor F2 620 in the table 600. The same unit 606 suffered 17% by volume and 6% by value when large losses (greater than $100 MM) are aggregated, under factors F3 630 and F4 640.

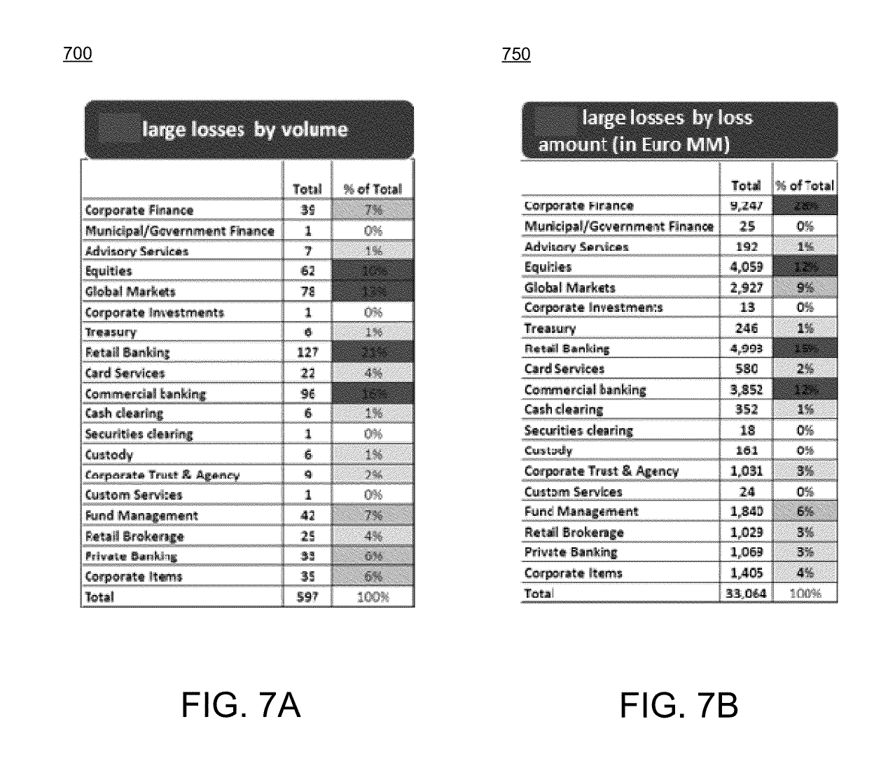

Additionally, for example, as illustrated in FIGS. 7A and 7B, tables 700 750 may be utilized to show additional management information for factors F5 and F6. Factors F5 and F6 may be based on external historical loss. Outside organizations may provide this information. FIG. 7A illustrates table 700 which shows an example of large external losses by volume. FIG. 7B illustrates table 750 which shows an example of large external losses by amount.

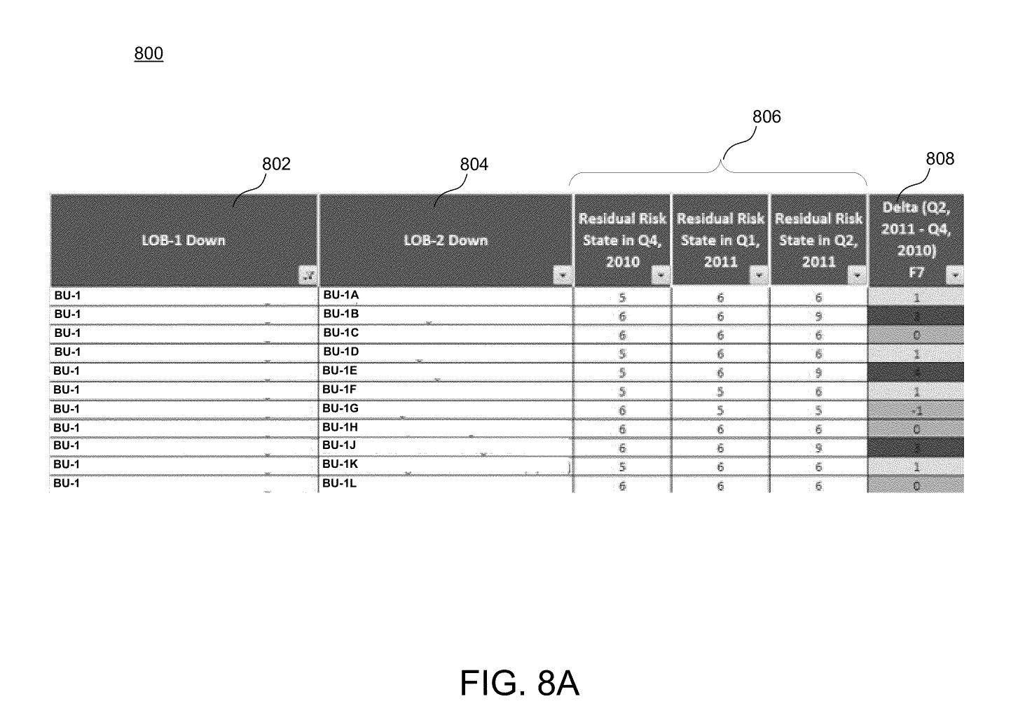

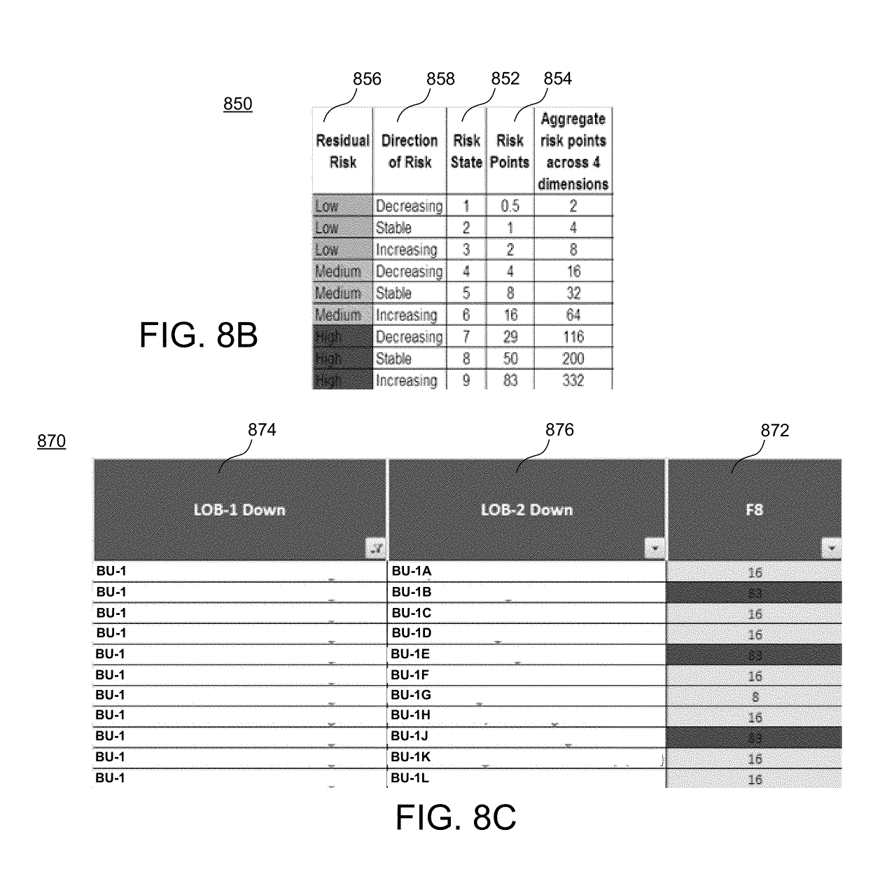

Additionally, additional management information for factors F7 through F10 may be based on a risk and control self-assessment (RCSA) process. FIG. 8A, in table 800, illustrates an example implementation for the global wealth and investment management business unit (LOB-1 down) 802 (represented as BU-1) with each of the sub units listed in LOB-2 down level 804 (represented as BU-1A through BU-1L). The table 800 lists residual risk states 806 of a given quarter as expressed on a scale of 3 to 9. Factor F7 808 is listed as the change in subsequent quarters and this may be captured as a trend.

FIGS. 8B and 8C, in tables 850 870, illustrates the current state of the residual risk. FIG. 8B, in table 850, specifically illustrates the current state of residual risk as depicted as “Risk Points” 852 on a 0.5 to 83 scale obtained from the risk state 854 (on a 1 to 9 scale) obtained from a combination of the residual risk 856 and the direction of the residual risk 858. FIG. 8C, in table 870, specifically illustrates the current state of residual risk, Factor F8 872, on a 0.5 to 83 scale for LOB-1 down 874 (represented as BU-1) and the associated LOB-2 down 876 (represented as BU-1A through BU-1L).

For factors F9 and F10, the above described method for factors F7 and F8 (for residual risk) may be applied to inherent risk (factors F9 and F10). Similar tables to tables 800 850 870 may be utilized similarly for inherent risk and factors F9 and F10.

Factors F11 through F18 may be based on emerging risks and changes in business/economic/control/regulatory/legislative/market environment. Risk and control self-assessment (RCSA) process may typically capture information including inherent risks, emerging risks, control effectiveness, and/or business unit profiling information. This information may be gathered during the RCSA process implementation, to include a core operational risk program element and a foundational block in the operational risk framework and practices of most organizations. This information may also be obtained through management information systems (MIS) based hard-data as opposed to line manager's assessments. For example, staff attrition rates may be obtained through human resource (HR) systems.

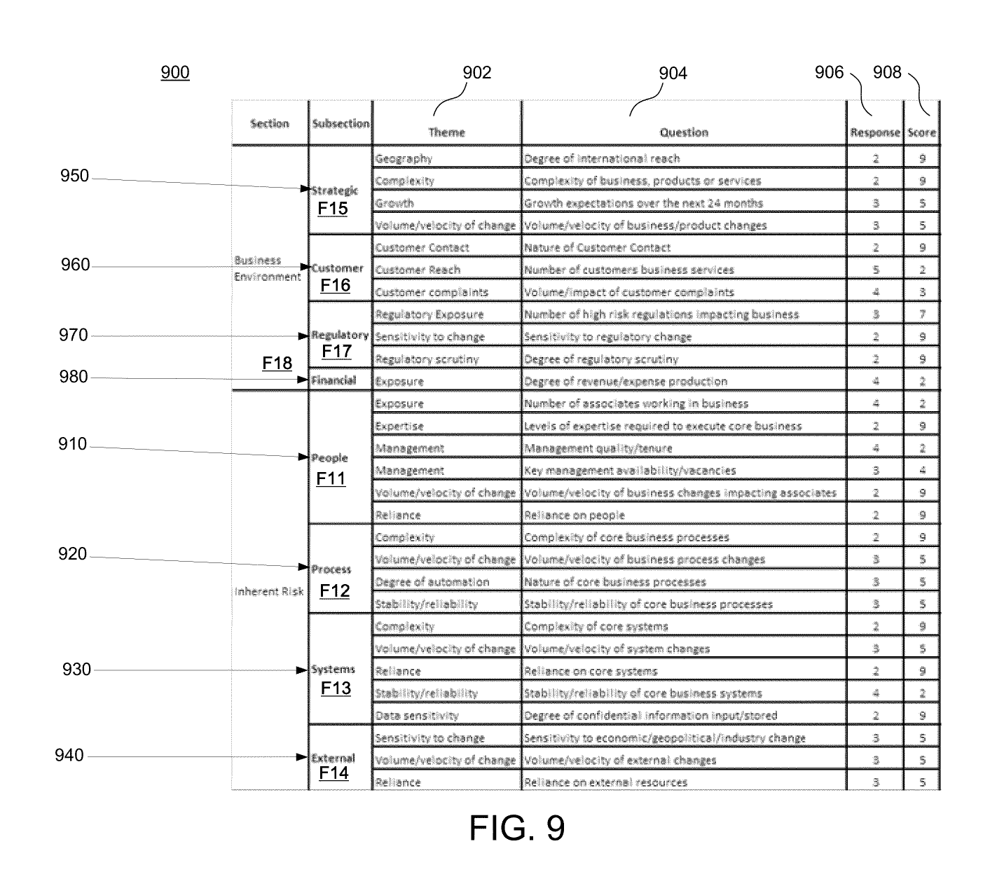

FIG. 9 illustrates an example table 900 that depicts factors F11 through F18. Table 900 is broken down into two sections, business environment and inherent risk, which include each of the factors or subsections F11 through F18. For each subsection, there may be a set of themes 902 and a corresponding question 904 for each theme 902. For a typical business unit, the response 906 for each of the above profiling questions can range from 1 to 5 reflecting upon the degree of segregation. Additionally, these responses can be translated into a 1 to 10 normalized score 908. Other ranges and scoring schemes are permitted and may be employed by those skilled in the art.

A core and critical aspect of this invention is the manner in which this profiling and business/control environment information is synthesized in the scenario selection methodology. As opposed to utilizing pure aggregation (e.g., mean scores, max scores), multiple pieces of information may be assembled together to determine key risk drivers. Below is a sample process to synthesize and profile the business/control environment information for each of the subsections/factors listed in Table 900 and identified as Factors F11 through F18. Note the “AND” vs. “OR” in the decisioning matrix for the emerging risk factors below.

As an example, for Factor F11, people factors 910, the following themes 902 and corresponding profiling questions 904 may be utilized: 1) Exposure—number of associates working in business; 2) Expertise—levels of expertise required to execute core business; 3) Management—management quality/tenure; 4) Management—key management availability/vacancies; 5) Volume/velocity of change—volume/velocity of business changes impacting associates; 6) Reliance—reliance on people. For people factors 910, Factor F11, the following emerging risk factor may be constructed: WHEN business is highly reliant on people (6) AND when a specialized skill-set is needed (2) THEN high volume/velocity of change (5) OR having many key management members new to role (3) (4) OR having high vacancies in key positions (1) leads to relatively high inherent/emerging risks. ** NOTE: The (#) represents the numbered profiling question 904 listed above.

As another example, for Factor F12, process factors 920, the following themes 902 and corresponding profiling questions 904 may be utilized: 1) Complexity—complexity of core business processes; 2) Volume/velocity of change—volume/velocity of business process changes; 3) Degree of automation—nature of core business process; 4) Stability/reliability—stability/reliability of core business processes. For process factors 920, Factor F12, the following emerging risk factor may be constructed: WHEN core business processes are complex (1) OR business processes are highly manual (with low degree of automation) (3), especially THEN stability of core business process (4) OR volume/velocity of change (2) is important.

As another example, for Factor F13, systems factors 930, the following themes 902 and corresponding profiling questions 904 may be utilized: 1) Complexity—complexity of core systems; 2) Volume/velocity of change—volume/velocity of system changes; 3) Reliance—reliance on core systems; 4) Stability/reliability—stability/reliability of core business systems; 5) Data sensitivity—degree of confidential information input/stored. For systems factors 930, Factor F13, the following emerging risk factor may be constructed: WHEN reliance on core systems is high (3) OR complexity of systems is high (1), THEN high volume/velocity of changes (2) OR high instability (or unreliability) of systems (4) OR high degree of confidential information input/stored (5) leads to relatively high inherent/emerging risks.

As another example, for Factor F14, external factors 940, the following themes 902 and corresponding profiling questions 904 may be utilized: 1) Sensitivity to change—sensitivity to economic/geopolitical/industry change; 2) Volume/velocity of change—volume/velocity of external changes; 3) Reliance—reliance on external resources. For external factors 940, Factor F14, the following emerging risk factor may be constructed: WHEN sensitivity to change (economic/geopolitical/industry) (1) is high AND reliance on external resources (3) is high, THEN high volume/velocity of change (2) leads to relatively high inherent/emerging risks.

As another example, for Factor F15, strategic factors 950, the following themes 902 and corresponding profiling questions 904 may be utilized: 1) Geography—degree of international reach; 2) Complexity—complexity of business, products, or services; 3) Growth—growth expectations over the next 24 months; 4) Volume/velocity of change—volume/velocity of business/product changes. For strategic factors 950, Factor F15, the following emerging risk factor may be constructed: WHEN business unit has high complexity of products/services (2) OR growth expectations are high (3) OR the degree of international reach is high (1), THEN volume/velocity of business product changes (4) leads to a volatile situation.

As another example, for Factor F16, customer factors 960, the following themes 902 and corresponding profiling questions 904 may be utilized: 1) Customer contact—nature of customer contact; 2) Customer reach—number of customers business services; 3) Customer complaints—volume/impact of customer complaints. For customer factors 960, Factor F16, the following emerging risk factor may be constructed: WHEN business unit is customer facing (1) AND complaints are high (3) relatively compared to the reach of customers (customer base) (2) leads to relatively high inherent/emerging risks.

As another example, for Factor F17, regulatory factors 970, the following themes 902 and corresponding profiling questions 904 may be utilized: 1) Regulatory exposure—number of high risk regulations impacting business; 2) Sensitivity to change—sensitivity to regulatory change; 3) Regulatory scrutiny—degree of regulatory scrutiny. For regulatory factors 970, Factor F17, the following emerging risk factor may be constructed: WHEN business unit has high sensitivity to regulatory change (2) AND regulatory exposure is relatively high (1) THEN heightened degree of regulatory scrutiny (3) is impactful.

As another example, for Factor F18, financial factors 980, the following theme 902 and corresponding profiling question 904 may be utilized: 1) Exposure—degree of revenue/expense production. For financial factors 980, Factor F18, the following emerging risk factor may be constructed: Degree of revenue/expense production has a high impact on the bottom line.

FIG. 4 illustrates another step in the process, inputting and recording the data for data manipulation and data analysis 410. This step may be utilized to aid in the ease of data manipulation and reporting results. For example, during this step, the observational data from the previous steps may be input into a spreadsheet or an equivalent application for data analysis.

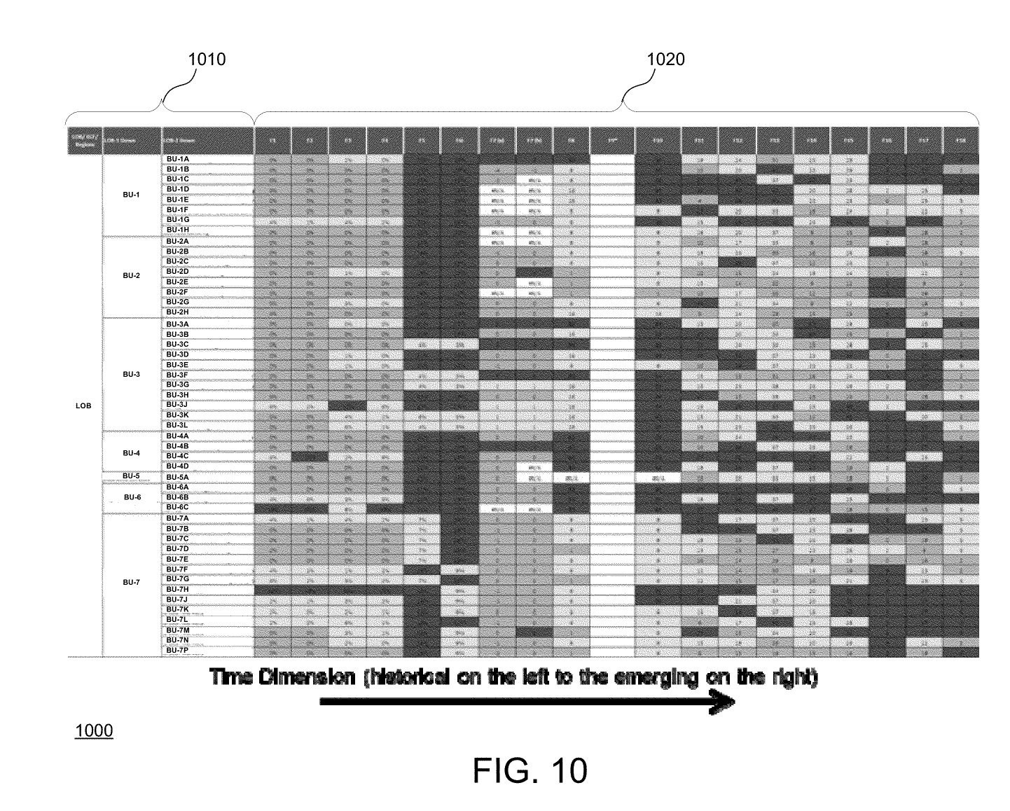

FIG. 5 illustrates another step in the process, visually depicting the output of the data into a 2-dimensional head map 412. The 2-dimensional heat-map may show the stresses on two dimensions with the use of colors. For example, the heat-map 1000 as illustrated in FIG. 10 provides a visual indication of the hotspots, showing hotspots in red and cautious spots in yellow. The left side of the heat map 1000 (with Factors F1 through F6) indicates an historical view. The right side of the heat map 1000 (with Factors F7 through F18) provides a view of the current and forward looking (emerging) risks. The first three columns may list the lines of business 1010, with the lines of business, LOB 1-down (represented as BU-1 through BU-7), and LOB 2 down (represented, for example, as BU-1A through BU-1H). The row headings may list the factors F1 through F18 1020 for each of the lines of business 1010.

FIG. 5 illustrates another step in the process, defining prioritization scheme keeping in alignment with the defined primary critical to quality (CTQs) 414. For the prioritization scheme, the following may be treated as a suggested prioritization scheme that may be utilized as an exemplary prioritization scheme. Other prioritization schemes may be easily applied and utilized without departing from this invention.

Weighted Score=Σ(wᵢ*Fₜ),
where: wᵢ=weights for individual factors and Fᵢ are the factors.

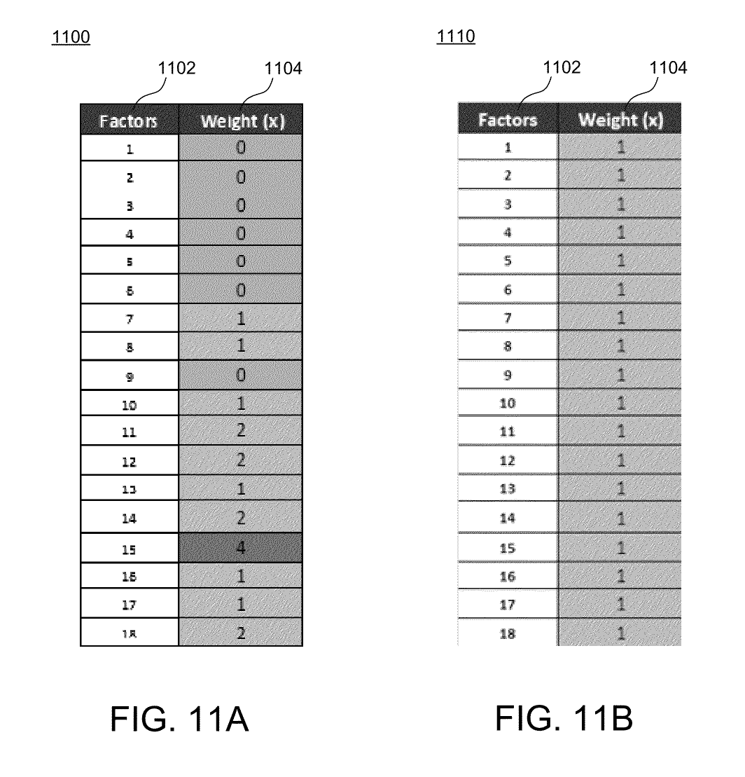

Example illustrations of factor weighting are illustrated in FIGS. 11A and 11B. FIGS. 11A and 11B illustrate tables with a list of each of the individual factors 1102 with the corresponding weight values 1104. FIG. 11A, table 1100, illustrates factor weighting wherein the historical factors (Factors F1 through F6) are not given much importance and more weight is given to emerging risks (Factors F7 through F18). FIG. 11B, table 1110, illustrates factor weighting where all factors (historical and emerging) are equi-weighted. Other weights and factors may be utilized and selected according those of skill in the art without departing from this invention. NOTE: Due care may be taken in the normalization of the data and factors on a uniform scale, before the weighted composite scores are computed. For example, all the factors may be scores on a 0-100 normalized scale.

FIG. 5 illustrates another step in the process, quantitatively synthesizing the data 416. During this step, the data may be synthesized 416 by normalizing the dataset, computing aggregate composite scores for each and every business unit, tabulating results, and lining up the candidate business units using aggregate composite scores. The data captured in the individual factor level may need to be normalized (e.g., on a 1-3, 0-10, or 0-100 scales—as examples). The normalization of the data will help so that the aggregate composite score may be computed using the prioritization scheme defined in the previous step 414. Although the choice of the scale impacts the total score on a magnitude basis, the scale should not impact the directionality of the end result if appropriate care is taken those skilled in the art.

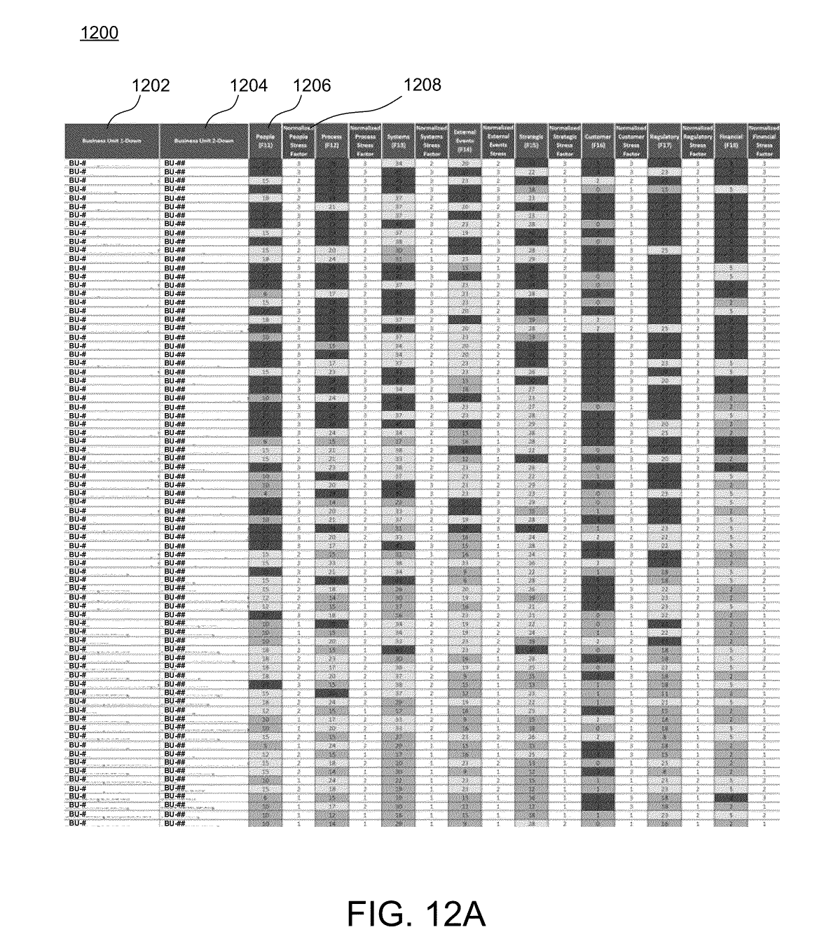

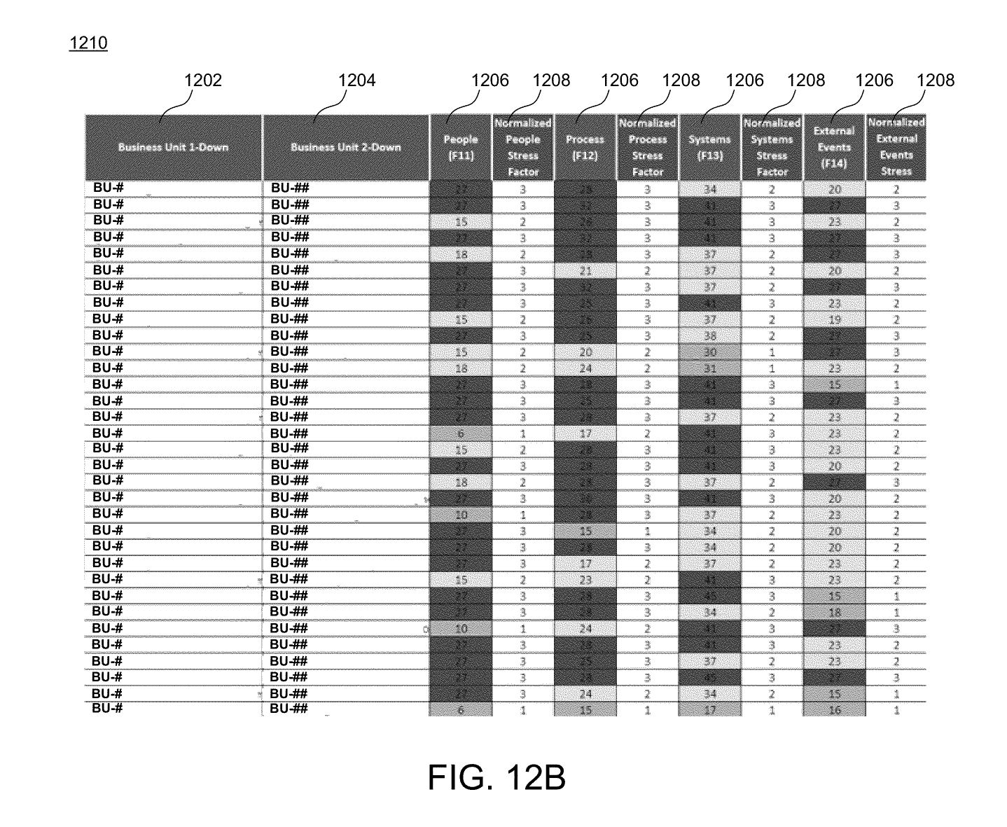

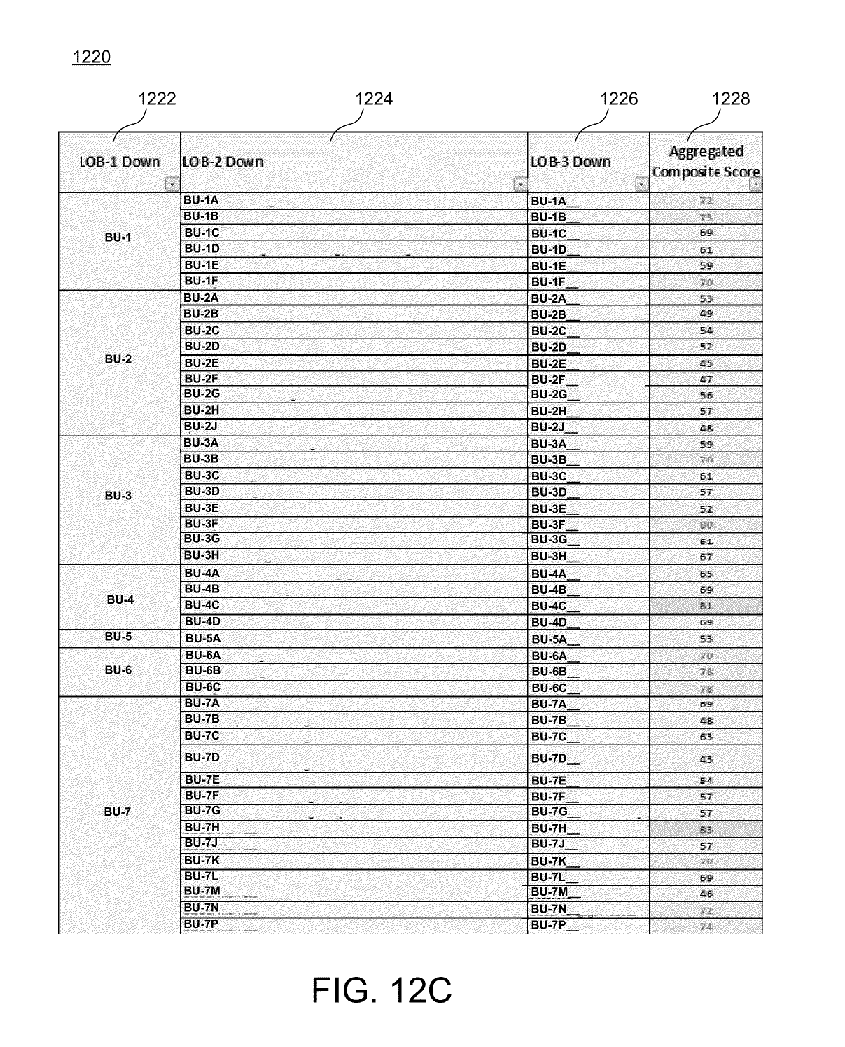

FIG. 12A, table 1200, illustrates an example implementation of the data analysis that includes the individual scores normalized to a 1-3 scale. FIG. 12B, table 1210, illustrates an enlarged portion for sake of readability. In the example tables, utilizing the 1-3 scale, the “green” individual scores may be normalized to a “1”, the “yellow” individual scores may be normalized to a “2”, and the “red” individual scores may be normalized to a “3”. As was stated above, other normalization scales may be utilized without departing from this invention. In FIGS. 12A and 12B, each of the different business units, business units 1-down 1202 (represented as BU-#), and business units 2-down 1204 (represented as BU-##) may be listed. Each factor 1206 with a normalized score may be listed for each of the business units 1-down 1202 and business units 2-down 1204.

After the aggregate score is computed for each of the business units (using the prioritization scheme defined in prior step 414), the business units can either be sorted based on the aggregate score or depicted on a heat scale using thresholds defined in the next step. FIG. 12C, table 1220, illustrates an example implementation using equal weights to all the factors. Table 1220 lists lines of business 1 down (LOB-1 Down) 1222 (represented as BU-1 through BU-7), lines of business 2 down (LOB-2 Down) 1224 (represented, for example, as BU-1A through BU-1F), lines of business 3 down (LOB-3 Down) 1226 (represented, for example, as BU-1A through BU-1F) and the corresponding aggregated composite score 1228. Colors in the last column 1228 may be based on thresholds and will be explained in the next process step 418.

FIG. 5 illustrates another step in the process, determining thresholds above which scenario planning is deemed helpful 418. Many different methods for determining thresholds may be utilized without departing from this invention. Two methods for determining thresholds are described below, but others methods may be easily extended to custom fit the organizational needs by those skilled in the art. A first method for determining thresholds may be by a Pareto process. For example, business units that scored the top 10% of the composite score may be strongly encouraged to perform scenario analysis, while business units that scored 10%-25% of the top score are moderately recommended to perform scenario analysis. A second method for determining thresholds may be to set an absolute number of the composite score (based on executive or stakeholder decisions). For example, business units with a composite score of greater than 80 (over a normalized scale of 0-100) may be strongly recommended to perform scenario analysis planning, while business units with a composite score of 70-80 may be moderately recommended to perform scenario analysis planning.

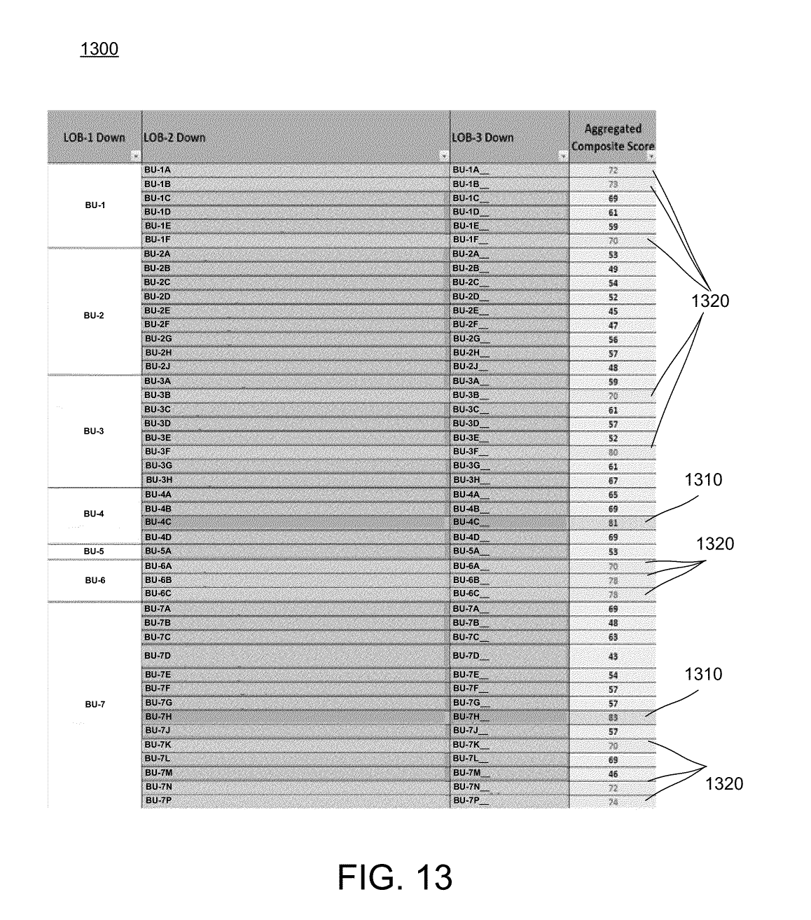

FIG. 13, table 1300, illustrates an example illustration of the utilization of thresholds. Utilizing the second methods of absolute numbers for the composite score, the thresholds are set at a score of over 80 with 2 of the business units 1310 are strongly encourage to perform scenario analysis and a further 11 of the business units 1320 that are moderately encouraged to perform the scenario analysis.

FIG. 5 illustrates another step in the process, conducting a “what-if-analysis” and sensitivity testing of the results 420. The tables 1220 1300 illustrated in FIGS. 12C and 13 and other example spreadsheet applications may provide a clear opportunity/means to perform “what-if-analysis.” Many different examples and or methods may be utilized to perform a what-if-analysis of the data. Generally, for what-if-analysis, there may be an adjustment of differing variables to see the change in the end outcome. The processes and methods for performing a what-if-analysis may include one or more of the following examples: (1) choice of factors may be increased or decreased based on firm specific implementation time, appetite, data availability and other considerations; (2) choice of individual weights for specific factors can be adjusted up or down; (3) choice of critical stress factors and the methodology of identifying stress scores can be tailored to go aggressive or conservative depending on firm-specific considerations; (4) choice of threshold for composite scores; (5) choice of business unit granularity; (6) choice of external historical loss data Fitch vs. ORX; (7) choice of timeframe used in historical loss factors (F1 through F6) with example 5 yr vs. 7.5 yrs vs. 10 yrs. Other processes and/or methods may be utilized for the what-if-analysis without departing from this invention.

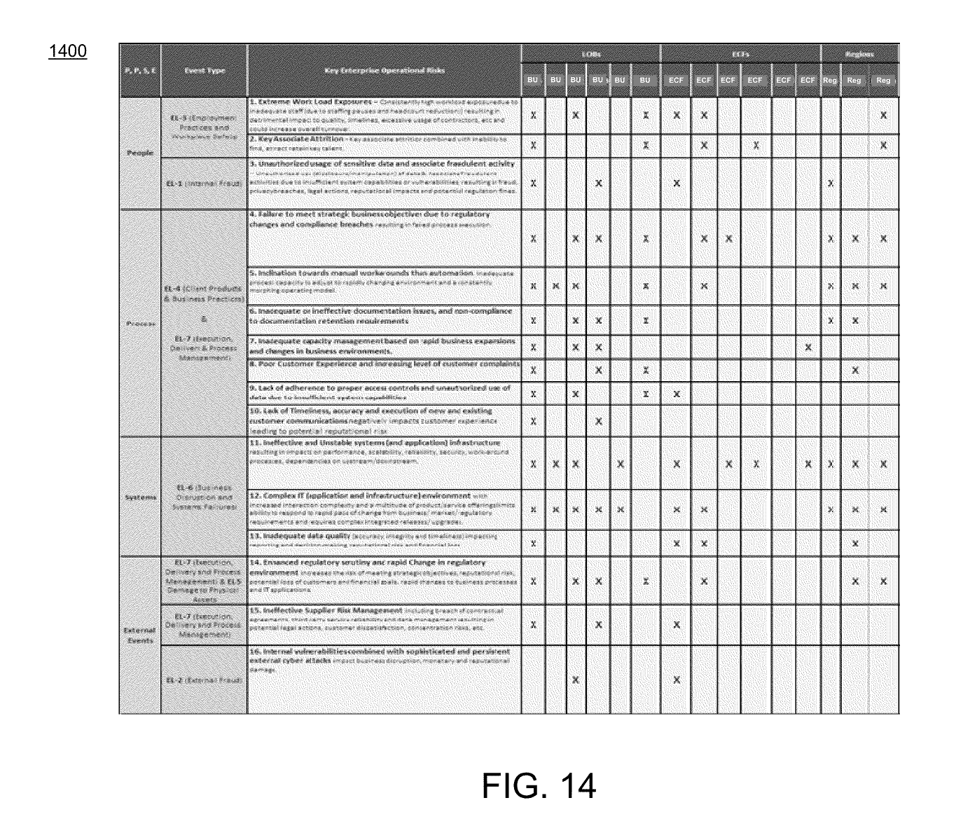

Additionally, this step 420 may include sensitivity testing. The RCSA process may allow for critical risks to be lined up by business units (as illustrated by table 1400 in FIG. 14). The lining up of critical risks by business units may serve as a pulse check of the scenario exercise of stressed areas (hot-spots) to be validated against the RCSA outcome. It may be adequate to have a disconnect between the composite scoring outcome and the RCSA outcome because the composite scoring outcome may have multiple decisioning factors and criteria built into the framework and more than likely the output is at variance with RCSA outcome.

Additionally, a by-product of the above exercise is not only the identification of business units for scenario testing, but also the identification of hot-spots or stress areas in individual business units. These stress areas may be pointers to specific scenarios that should be considered for the scenario planning exercise. Even if a certain business unit scored not very high in the composite aggregate and hence is not in the required list (to run scenario workshops), a business unit may show extreme stresses at an individual emerging risk theme (between factors F11 through F18) and that business unit may benefit from a “surgical” or focused scenario workshop (focusing on just that theme). For example, a business unit-X may have scored in the 50^{th} percentile on an overall aggregate composite score, but scores in the 95^{th} percentile in people (F11) and financial stresses (F18). This business unit may benefit from running a scenario workshop in only these two areas.

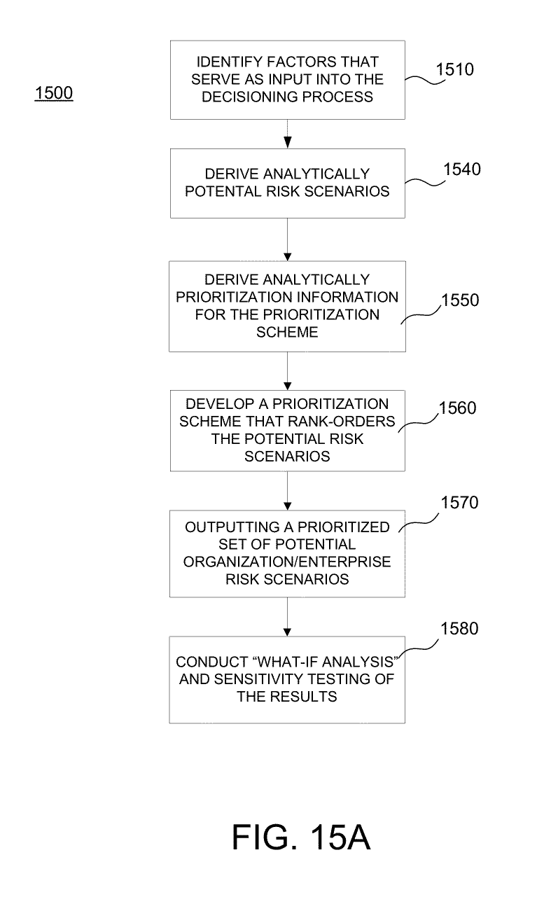

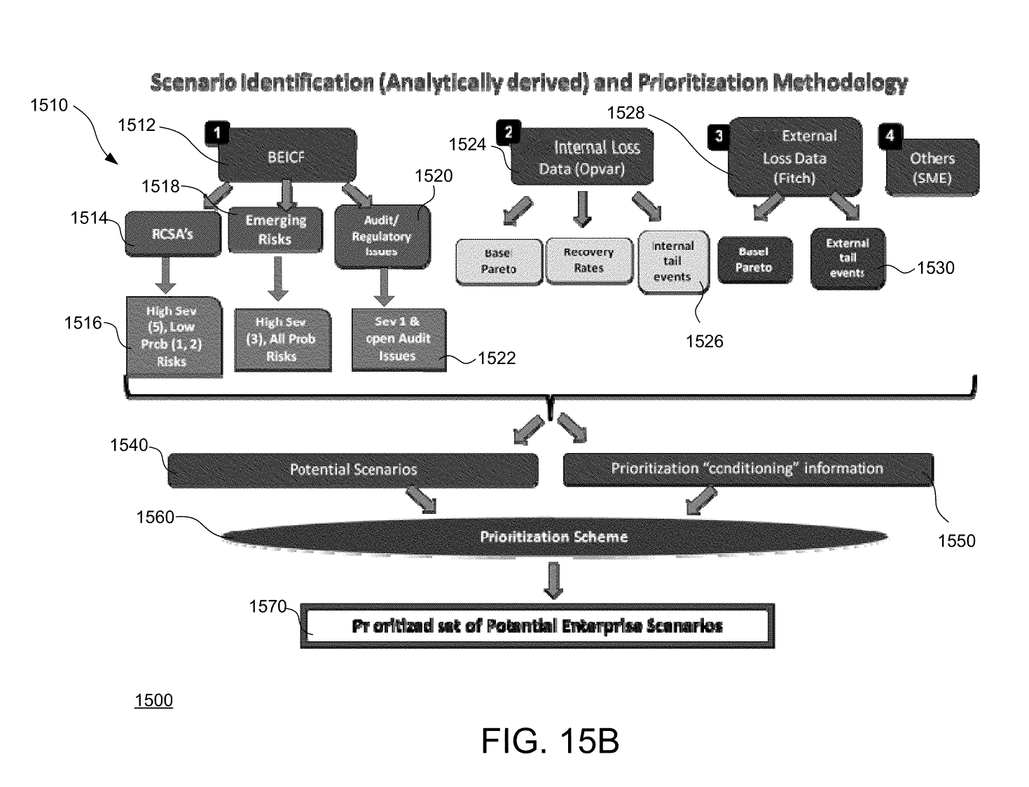

After business units have been identified for scenario testing, the second portion of this invention provides processes and methods for identifying scenarios for operational scenario analysis using analytical and quantitative methods. FIGS. 15A and 15B illustrate a flow chart 1500 for identifying scenarios for operational scenario analysis using analytical and quantitative methods in accordance with an aspect of the invention. As illustrated in FIGS. 15A and 15B, the method may include one or more of the following steps: 1) identifying factors that serve as input into the decisioning process 1510; 2) analytically deriving potential scenarios from multiple sources of pertinent risk information 1540; 3) analytically deriving prioritization information from multiple sources of pertinent risk information 1550; 4) developing a prioritization scheme that rank-orders the potential scenarios 1560; 5) outputting a prioritized set of potential organization/enterprise scenarios 1570; and 6) conducting “what-if-analysis” and sensitivity testing of the results 1580.

As illustrated in FIG. 15B, the identifying a set of risk information 1510 step includes gathering and identifying information from a variety of different sources. One example source of risk information may be from Business Environment and Internal Control Factors (BEICF) 1512. Those BEICF 1512 may include risk and control assessments (RCSA) risks 1514. These risks may be focused on tail events, wherein only high-severity (or ultra-high-severity) risk and low to moderate likelihood events 1516 are considered. Additionally, another example source of risk information may be from emerging risks 1518. For emerging risks 1518, the BEICF information may be utilized. Typical emerging risk information may be found in self-assessments (RSA), audit issues 1520, and emerging risk forums. Only the high severity and low-to-moderate likelihood risks 1522 may be extracted from the emerging risk information 1518. Audit/regulatory issues 1520 may include business self-identified, corporate audit identified, and regulator identified. Again, only the high severity audit items and open audit issues 1522 may be extracted from the audit/regulatory issues 1520.

FIG. 15B illustrates another source of risk information, internal loss data 1524. Internal loss data 1524 may be derived from a Basel Pareto chart, recovery rates, and/or internal tail events 1526. Internal tail events 1526 may be defined by a gross loss of greater than a given number, such as gross loss greater than say $100 million for a given period. Generally, it is common to mistakenly assume that the internal loss data 1524 is not a good informational input for scenario determination, partly because a given organization or firm would not have witnessed a particular scenario pan out into a tail event. However, there is clear value to utilize internal loss data 1524. Previous experience should not be under-estimated, primarily because it gives a point of view of business unit exposure, by looking at a historical loss heat-map. Generally, a historical loss heat map may be utilized to show past historical pain points and loss recovery rate information. This information may then be synthesized to arrive at candidate internal tail risks 1526.

In addition to the internal loss data 1524 and history, the loss recovery rates should be factored in as well. The nature of recovery rates may be fairly specific to organizations and firms. Generally these recovery rates depends on the type of risk transfer strategies employed through, for example, insurance, and the types of policies and experience set forth the actual recovery rates.

Prior experience and external loss history 1528 is illustrated as another source of risk information in FIG. 15B. External loss data 1528 may be derived from a Basel Pareto chart, and/or external tail events 1530. External tail events 1530 may be defined by a gross loss of greater than a given number, such as gross loss greater than say $100 million for a given period. Again, it is common to mistakenly assume that the external loss data 1528 is not a good informational input for scenario planning as this may be deemed not relevant to the organization or the firm. However, combined experience of peer group may be valuable to a given organization or firm as this is something that was suffered by a peer organization. It is important to tap into the external loss information 1528, however, the information and specific events may be scrutinized for specific applicability to the organization or firm. Again, a historical loss heat map may be utilized to show past historical external pain points. This information may then be synthesized to arrive at candidate external tail risks 1530.

FIG. 15B illustrates another source of risk information that includes other sources and specifically subject-matter-expertise (SME) 1532. Business and risk subject-matter-expertise may also form another element in the informational input to identify candidate risk scenarios. All of the sources of risk information and informational inputs not only provide the method/process with a candidate risk scenario list, but also provide the prioritization and/or conditioning information.

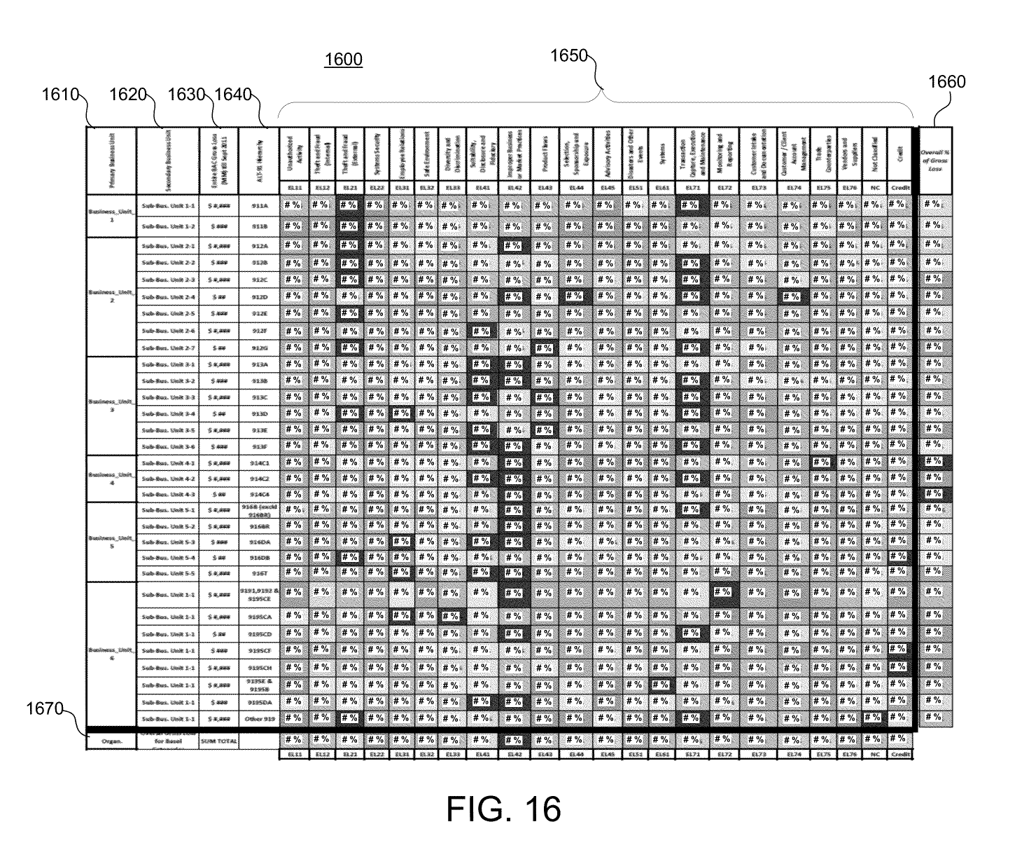

FIG. 16 illustrates a historical loss heat-map 1600 that may be utilized to identify historical risks in accordance with aspects of this invention. The heat-map 1600 may be unique to every firm or organization. A historical loss heat map may be utilized to identify and report historical losses in two dimensions (one by business unit and other by risk event type). The historical loss heat-map 1600 may include a variety of different columns and rows. Generally, the columns along the left side of the historical loss heat-map 1600 represent business units with exposure to operational losses. Generally, the rows along the top side of the historical loss heat-map 1600 represent operational risk event types. The percentage numbers in the middle of the historical loss heat-map 1600 represent operational loss expressed as a percentage, with higher numbers representing a higher risk and the lower numbers representing a lower risk. The historical loss heat-map 1600 may include a column for primary business units 1610. In addition to the primary business units 1610, each primary business unit 1610 may have a list of secondary business units 1620.

Additionally, another column may be the gross loss 1630 (in millions of dollars) for each secondary business unit 1620. Another column in the heat-loss map 1600 may include the “ALT-91” hierarchy 1640 (a Basel category rating) for each secondary business unit 1620. Furthermore, the ending columns list the percentage loss in each of the various Basel categories 1650 for each secondary business unit 1620. Colors may be utilized to illustrate various breakdowns of percentage losses. In the final column is listed the percentage of the total loss 1660 across each secondary business unit 1620. In the final row of the heat-loss map 1600 is a percentage loss total 1670 across each Basel category 1650.

A heat map structure may be utilized to identify and report historical operational losses and present the information in two dimensions (one by business units and other by risk event type). Risk event types may be internal fraud, external fraud, employment practices and workplace safety, clients, products and business practices, damage to physical assets, business disruption and systems failure, and execution, delivery and process management risks. The choice of historical time-frame may be five year or more or less. The “heat” illustrates the severity of exposure of a given business unit to a specific kind of risk relative to other business units and/or other risk event types. Similar heat-map can be constructed to show-case operational loss event volume (frequency) as opposes to loss amount (severity), since they complement each other.

Emerging risks may validate and adjust units-of-measure through core risk management programs. Core risk management programs may include but not be limited to: emerging risks, scenario analysis, and risk and control self-assessment (RCSA) process. Generally, self-assessment programs, such as RCSAs, may identify the state of key risks and controls. High residual risks may be good candidates for key risks. Additionally, high inherent risks may be next in line for good candidates for key risks to be identified. In an organization, typically inherent risks and residual risks are categorized into High, Medium and Low.

FIGS. 15A and 15B illustrate the next steps in the process, analytically deriving potential risk scenarios 1540 from the risk information from the previous step and analytically deriving prioritization information for the prioritization scheme 1550 using the risk information from the previous step. When analytically deriving potential risk scenarios 1540 and analytically deriving prioritization information for the prioritization scheme 1550, current state of controls and residual risk (via self-assessment or audit assessment) may be factored. The candidate risk scenarios may be grouped under people, process, systems, and external events (PPSE). The candidate risk scenarios may also be grouped using the Basel categorization scheme (either Level-1 or Level-2). The grouping/categorization ensures that each category receives focused attention in the selection/determination process.

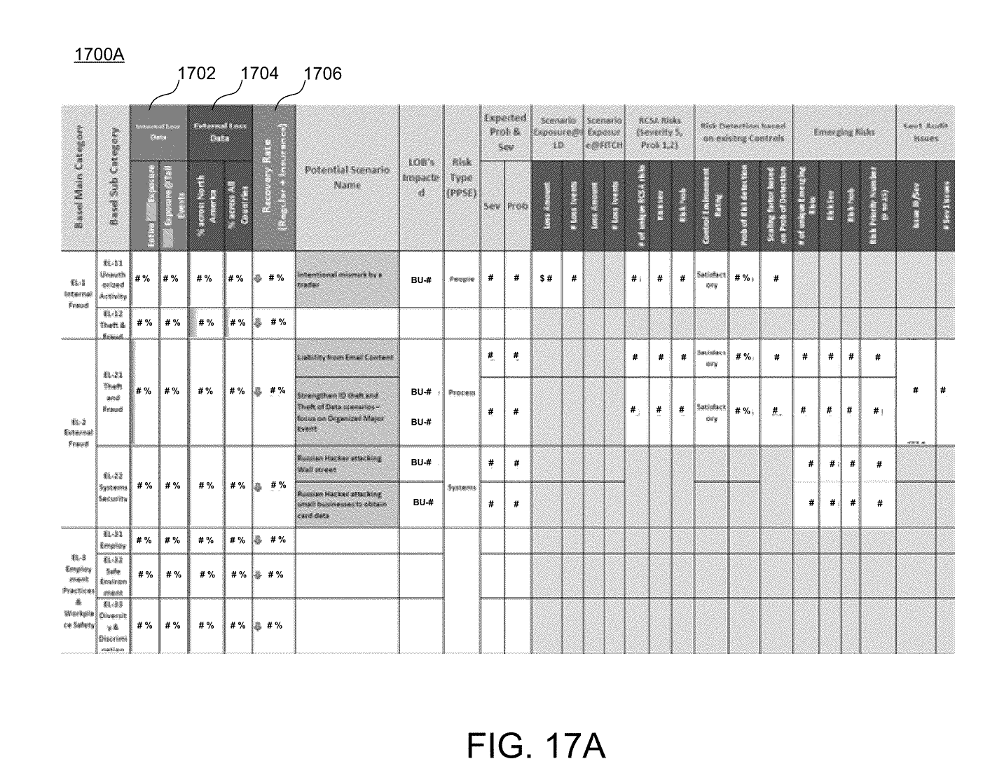

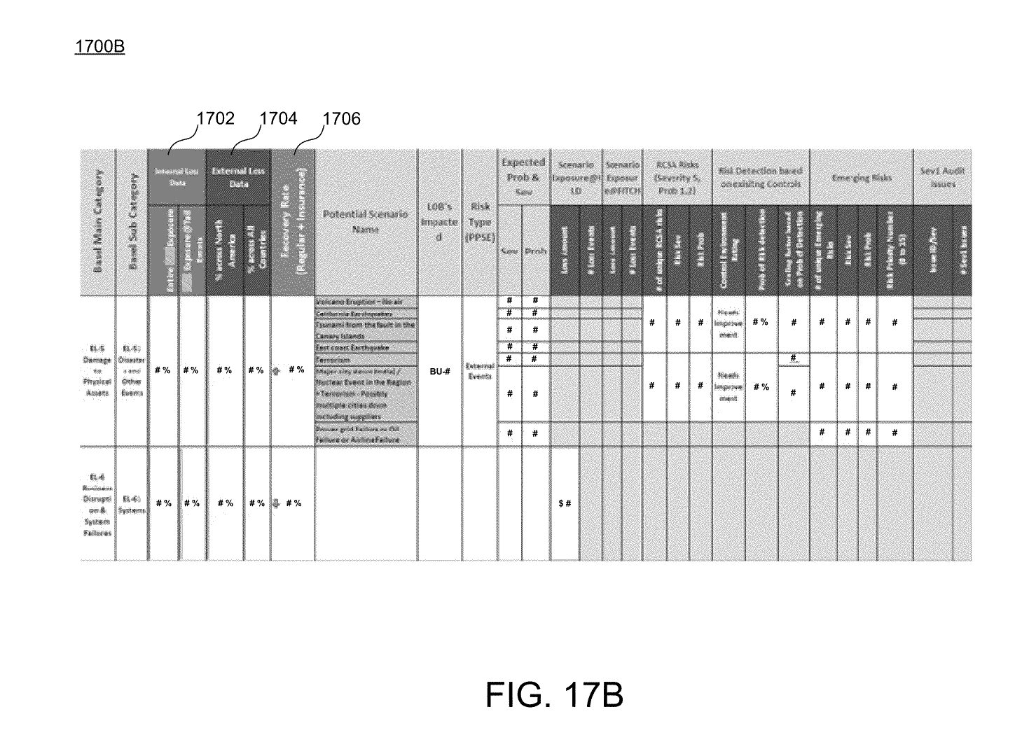

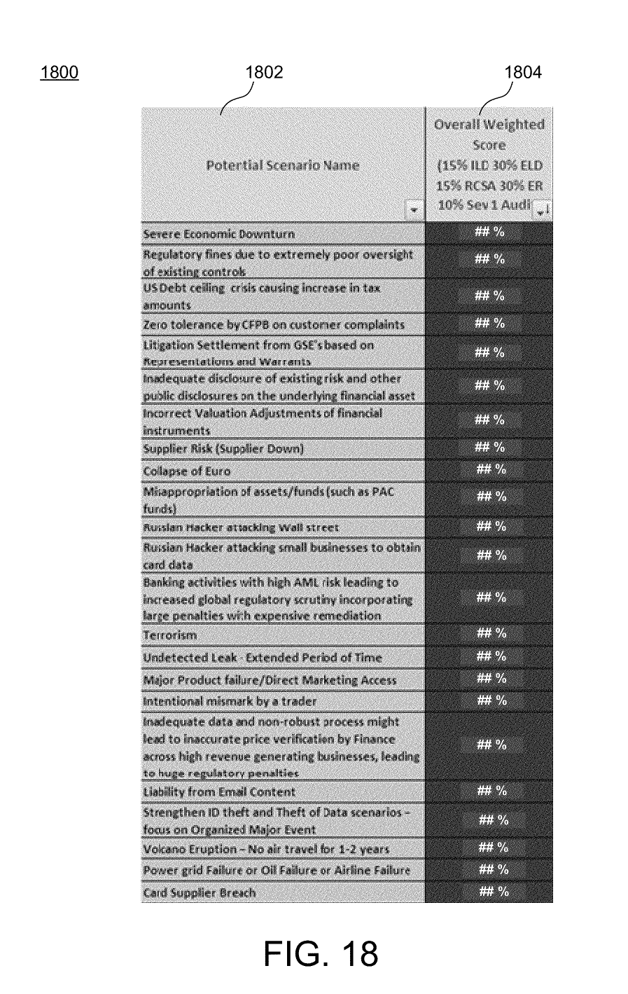

The next step in the process as illustrated in FIGS. 15A and 15B is the deriving the scenario prioritization scheme 1560 keeping in alignment with defined primary critical to quality parameters (CTQs). Each of the core components may be individually assigned a weight. The core components may include internal loss 1524, external loss 1528, RCSA emerging tail risks 1516, and audit issues 1520. The total of the weights should equal 100%. An example implementation may be 15% weight to internal loss, 30% to external loss, 15% to RCSA, 30% to Emerging Risks and 10% to Severity-1 Audit identified issues. Other choice of weights may be selected without departing from this invention. Following the prioritization scheme 1560, the next step is outputting a prioritized set of potential organization/enterprise risk scenarios 1570. This step 1570 may be accomplished with one or more of the following: visually depicting the output in a 2-dimensional map to show the opportunities for risk scenarios on two dimensions, normalizing the data, computing aggregate composite scores for each and every business unit, and tabulating results. FIGS. 17A and 17B illustrate a 2-dimensional map in tables 1700A and 1700B. Tables 1700A and 1700B are a continuation of each other. As illustrated in FIGS. 17A and 17B in tables 1700A and 1700B, a 2-dimensional map is illustrated which shows internal historical tail events 1702, external loss data 1704, and loss recovery rate information 1706 which is all synthesized to arrive at candidate tail risks. The candidate scenarios may then be rank-ordered using the aggregate composite scores. An example implementation of rank-ordering the candidate scenarios using aggregate composite scores is illustrated in FIG. 18 as table 1800. In table 1800, a potential scenario name 1802 is listed with a corresponding overall weighted composite score 1804.

The last step, as illustrated in FIGS. 15A and 15B is conducting “what-if-analysis” and sensitivity testing of the results 1580. One of the advantages of the prioritization scheme 1560 is that the relative weights may be adjusted and the resulting output may be reviewed for changes. Adjusting the relative weights may allow for the processing and use of the what-if exercises. The relative maturity of the individual program elements (internal loss 1524 vs. external loss 1528 vs. RCSA emerging tail risks 1516 vs. audit issues 1520) as well as the comprehensiveness of historical loss data and the confidence in the data may all help to determine the relative weights to each program element. Additionally, the methods/process develops a needed transparency as to why certain risk scenarios were selected over other risk scenarios.

Additional embodiments of this invention may include a broader and bigger market beyond the domestic United States. Basel II compliance may be phased with Europe and other North American early pioneers, compared to other regions/countries. The aspects and embodiments of this invention may be utilized within the United States and outside of the United States. Even though regional central banks and organizations may extend the Basel II framework for regulatory compliance and guidelines, by and large, many other countries follow the guidelines set for in the United States. Many firms and organizations (even non-banking and non-financial sector) apply scenario analysis in decision making. The concept of the use of scenario analysis in decision making is industry agnostic, so many other industries and organizations may utilize the scenario analysis process as described without departing from this invention.

Aspects of the embodiments have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the embodiments. They may determine that the requirements should be applied to third party service providers (e.g., those that maintain records on behalf of the company).

We claim:

1. A computer-assisted method comprising:
identifying a set of risk factors;
analytically deriving, by a risk scenario computer system, potential risk scenarios from the set of risk factors;
analytically deriving, by the risk scenario computer system, prioritization information from the set of risk factors;
developing a prioritization scheme that rank-orders the potential risk scenarios; and
outputting, by the risk scenario computer system, a prioritized set of potential risk scenarios, wherein the prioritized set of potential risk scenarios identifies risk scenarios for operational risk scenario analysis.

2. The method of claim 1, further comprising:
conducting, by the risk scenario computer system, what-if-analysis testing of the prioritized set of potential risk scenarios.

3. The method of claim 2, wherein the what-if-analysis testing includes changing parameters during the deriving of potential risk scenarios step.

4. The method of claim 2, wherein the what-if-analysis testing includes changing parameters during the deriving of prioritization information step.

5. The method of claim 1, wherein the set of risk factors includes emerging risk information.

6. The method of claim 1, wherein the set of risk factors includes internal loss data derived from a Basel Pareto chart, loss recovery rates, and/or internal loss tail events.

7. The method of claim 1, wherein the set of risk factors includes external loss data derived from a Basel Pareto chart and/or external loss tail events.

8. An apparatus comprising:
at least one memory; and
at least one processor coupled to the at least one memory and configured to perform, based on instructions stored in the at least one memory:
defining critical to quality measures of success and line of business granularity, wherein the line of business granularity defines a set of line of businesses for assessing a scenario analysis;
identifying a set of risk factors and obtaining information related to the set of risk factors;
defining a prioritization scheme for the set of risk factors, wherein the prioritization scheme is aligned with the critical to quality measures of success;
quantitatively synthesizing the set of risk factors and the prioritization scheme, wherein the quantitative analysis includes normalizing the data, and calculating a composite score for each of the lines of business within the set of line of businesses;
determining risk factor thresholds above which business unit scenario planning is deemed necessary for each of the lines of business within the set of line of businesses; and
selecting a business unit based on the risk factor thresholds for scenario planning.

9. The apparatus of claim 8, wherein the set of risk factors includes extreme internal loss factors, large internal loss factors, large external loss factors, self-assessed residual risk factors, and self-assessed inherent risk factors.

10. The apparatus of claim 9, wherein the extreme internal loss factors, large internal loss factors, and large external loss factors further include number of loss events and severity of the loss events.

11. The apparatus of claim 9, wherein the self-assessed residual risk factors and the self-assessed inherent risk factors further include risk trends over time and the current state of risk.

12. The apparatus of claim 8, wherein the set of risk factors includes environmental stress factors and emerging risks that include one or more of the following: people factors, process factors, systems factors, external events, strategic factors, customer factors, regulatory factors, and financial factors.

13. The apparatus of claim 8, wherein the set of risk factors further includes synthesizing the set of risk factors for each factor to determine key risk drivers using non-aggregation methods.

14. The apparatus of claim 8, wherein the risk factor thresholds are determined by a Pareto process with the composite score.

15. The apparatus of claim 8, wherein the risk factor thresholds are determined by a setting an absolute number for the composite score.

16. A computer-readable storage medium storing computer-executable instructions that, when executed, cause a processor to perform a method comprising:
defining critical to quality measures of success and line of business granularity, wherein the line of business granularity defines a set of line of businesses for assessing a scenario analysis;
identifying a set of risk factors and obtaining information related to the set of risk factors;
defining a prioritization scheme for the set of risk factors, wherein the prioritization scheme is aligned with the critical to quality measures of success;
quantitatively synthesizing, by a risk scenario computer system, the set of risk factors and the prioritization scheme, wherein the quantitative analysis includes normalizing the data, and calculating a composite score for each of the lines of business within the set of line of businesses;
determining risk factor thresholds above which business unit scenario planning is deemed necessary for each of the lines of business within the set of line of businesses; and
selecting a business unit based on the risk factor thresholds for scenario planning.

17. The computer-readable medium of claim 16, wherein the method further comprises:
conducting, by the risk scenario computer system, what-if-analysis testing and sensitivity testing of the quantitative analysis of the set of risk factors and the prioritization scheme.

18. The computer-readable medium of claim 16, wherein the set of risk factors further includes synthesizing the set of risk factors for each factor to determine key risk drivers using non-aggregation methods.

19. An apparatus comprising:
at least one memory; and
at least one processor coupled to the at least one memory and configured to perform, based on instructions stored in the at least one memory:
identifying a set of risk factors;
analytically deriving potential risk scenarios from the set of risk factors;
analytically deriving prioritization information from the set of risk factors;
developing a prioritization scheme that rank-orders the potential risk scenarios;
outputting a prioritized set of potential risk scenarios, wherein the prioritized set of potential risk scenarios identifies risk scenarios for operational risk scenario analysis; and
conducting what-if-analysis testing of the prioritized set of potential risk scenarios.

20. The apparatus of claim 19, wherein the what-if-analysis testing includes one or more of:
changing parameters during the deriving of potential risk scenarios step and/or changing parameters during the deriving of prioritization information step.
